(19) United States
(12) Patent Application Publication
(10) Pub. No.: US 2012/0133907 A1
(43) Pub. Date: May 31, 2012

(54) COOLING UNIT, COOLING APPARATUS, AND PROJECTION DISPLAY APPARATUS

(75) Inventors: Sosuke Otani, Nara-City (JP); Makoto Maeda, Nara-City (JP); Shinya Matsumoto, Uji-City (JP); Yusuke Ito, Toyonaka-City (JP); Masafumi Tanaka, Hirakata-City (JP)

(73) Assignee: SANYO ELECTRIC CO., LTD., Osaka (JP)

(21) Appl. No.: 13/307,837

(22) Filed: Nov. 30, 2011

(30) Foreign Application Priority Data
Nov. 30, 2010 (JP) 2010-266958
Jan. 26, 2011 (JP) 2011-014470
Mar. 7, 2011 (JP) 2011-049378
Mar. 7, 2011 (JP) 2011-049379

(51) Int. Cl. G03B 21/16; F28D 15/00

(52) U.S. Cl. 353/58; 165/104.34; 353/52; 353/61

(57) ABSTRACT

A projection display apparatus comprising: a housing member that accommodates an illumination optical unit; a projection optical unit; and a cooling unit, wherein the housing member includes a layout space in a virtually columnar shape having a bottom that is a circumscribed circle of the projection optical unit in a cross sectional view vertical to the projection optical unit; the layout space includes a first layout space in a substantially conical shape and a second layout space excluding the first layout space; the projection optical unit is provided in the first layout space; and at least a part of the illumination optical unit and the cooling unit is provided in the second layout space; and the illumination optical unit and the cooling unit are disposed in a symmetrical positional relationship with respect to the projection optical unit.

### CROSS REFERENCE TO RELATED APPLICATIONS

This application is based upon and claims the benefit of priority from prior Japanese Patent Application No. 2010-266958, filed on Nov. 30, 2010, prior Japanese Patent Application No. 2011-014470, filed on Jan. 26, 2011, prior Japanese Patent Application No. 2011-049378, filed on Mar. 7, 2011, and prior Japanese Patent Application No. 2011-049379, filed on Mar. 7, 2011; the entire content of which is incorporated herein by reference.

### BACKGROUND OF THE INVENTION

1. Field of the Invention

The present invention relates to a projection display apparatus including a housing member that accommodates an illumination optical unit, a projection optical unit, and a cooling unit, the cooling unit and a cooling apparatus used for the projection display apparatus.

2. Description of the Related Art

Conventionally, a projection display apparatus have been known that include a projection optical unit projecting light emitted from an illumination optical unit onto a projection plane. The illumination optical unit includes, for example, a light source such as a LED (light emitting diode) and an imager that modulates light emitted from the light source. Moreover, the projection display apparatus includes a cooling unit such as a heat sink that cools the light source.

In the general projection display apparatus, the illumination optical unit and the projection optical unit are disposed so that an optical axis of the illumination optical unit is vertical to the optical axis of the projection optical unit (for example, JP, 2004-45718).

There is a need for arranging the projection optical unit at a center of a housing member that accommodates the illumination optical unit, the projection optical unit, and the cooling unit. Moreover, the housing member in a small size is also desired.

Since, the optical axis of the illumination optical unit is vertical to the optical axis of the projection optical unit in the general projection display apparatus, it is difficult to accommodate the projection optical unit placed in the center of the housing member, and to downsize the housing member that accommodates the illumination optical unit and the projection optical unit.

### SUMMARY OF THE INVENTION

A projection display apparatus (projection display apparatus 100) according to a first feature includes a housing member (housing member 200) that accommodates an illumination optical unit (illumination optical unit 310), a projection optical unit (projection optical unit 320), and a cooling unit (cooling apparatus 330). The housing member includes a layout space (layout space 400) in a virtually columnar shape including a bottom that is a circumscribed circle of the projection optical unit on a vertical cross sectional plane with respect to the optical axis of the projection optical unit. The layout space includes a first layout space (first layout space 410) in a substantially conical shape and a second layout space (second layout space 420) excluding the first layout space. The projection optical unit is disposed in the first layout space. At least a part of the illumination optical unit and cooling unit is disposed in the second layout space. The illumination optical unit and the cooling unit are disposed in a symmetrical positional relationship with respect to the projection optical unit.

In a first feature, the cooling unit is connected to the illumination optical unit by a heat pipe.

In the first feature, the illumination optical unit includes a light source and an imager that modulates light emitted from the illumination optical unit. The housing member accommodates a duct that forms an airflow path for leading heat generated by the imager to an outside of the housing member. The duct also forms an airflow path for leading heat absorbed by the cooling unit to the outside of the housing member.

In the first feature, the projection display apparatus includes a fan that forms airflow from an upper side to a lower side, in the airflow path formed the duct.

The projection display apparatus (projection display apparatus 100) according to a second feature includes the housing member (housing member 200) that accommodates the illumination optical unit (illumination optical unit 310), the projection optical unit (projection optical unit 320), and the cooling unit (cooling apparatus 330). In a front view of the housing member, the illumination optical unit and the cooling unit are disposed in the symmetrical positional relationship with respect to the projection optical unit. In a side view of the housing member, the illumination optical unit and the cooling unit are disposed to overlap the projection optical unit.

A cooling unit (cooling unit 1400) according to a third feature includes a plurality of cooling fins (cooling fins 1430) connected to a heat pipe (heat pipe 1420) and disposed at a predetermined interval along a direction where the heat pipe extends. The cooling fins include a fin body (fin body 1431) in a plate shape that includes a main surface vertical to a direction in which the heat pipe extends and the airflow guiding wall (airflow guiding wall 1432) that includes an airflow guiding surface vertical to the main surface. The airflow guiding wall is provided to lead cooling air supplied to the plurality of cooling fins into a different direction.

In the third feature, the main surface has a rectangular shape. The airflow guiding wall is provided along with two sides that are adjacent to each other on the main surface.

In the third feature, the cooling unit includes a first cooling fins provided in the first individual unit connected to a first heat pipe as the cooling fins, and includes a second cooling fins provided in the second individual unit connected to a second heat pipe as the cooling fins. The first individual unit and the second individual unit are disposed so that the cooling air is led from the first individual unit to the second individual unit.

In the third feature, the first individual unit is used to cool a first heat source. The second individual unit is used to cool a second heat source having calorific amount smaller than calorific amount of the first the heat source. The first individual unit and the second individual unit are disposed to lead the cooling air from the first individual unit to the second individual unit.

A projection display apparatus according to a fourth feature includes the cooling unit according to the third feature.

A cooling unit (second cooling unit 2720) according to a fifth feature includes an inlet (inlet 2212A) that draws in cooling air from an outside and an outlet (outlet 2213A) that draws out the cooling air to the outside. An airflow path that connects the inlet (inlet 2212A) and the outlet (outlet 2213A) has a turning shape, and an outbound path from the inlet (inlet 2212A) and an inbound path to the outlet (outlet 2213A) are adjacent to each other.

In the fifth feature, at least one cooling member (cooling fins 2430) is disposed in each of the outbound path and the inbound path.

In the fifth feature, the airflow path from the inlet (inlet 2212A) to the outlet (outlet 2213A) and the cooling member (cooling fins 2430) is covered with a duct (duct 2312A).

A cooling apparatus (cooling apparatus 2700) according to a sixth feature includes the cooling unit (second cooling unit 2720) according to the fifth feature and another cooling unit (first cooling unit 2710) that is different from the cooling unit. The outlet (outlet 2213A) of the cooling unit (second cooling unit 2720) and the outlet (outlet 2213B) of the another cooling unit (first cooling unit 2710) are oriented in the same direction.

In the sixth feature, the cooling apparatus further includes a cooling fan (fan 2311A) disposed in the cooling unit (second cooling unit 2720) that draws in or draws out the cool air, and another cooling fan (fan 2311B) disposed in the another cooling unit (first cooling unit 2710) that draws in or draws out the cool air. The cooling fan (fan 2311A) and the another cooling fan (fan 2311B) are provided at positions of opposing corners.

A projection display apparatus according to a seventh feature includes the cooling unit (second cooling unit 2720) or the cooling apparatus (2700) according to the sixth feature.

A projection display apparatus according to an eighth feature includes a housing member, a light source that emits the light, an imager that modulates the light from the light source based on an image input signal, a projection optical unit that enlarges and projects the modulated light from the imager onto a projection plane, and a cooling unit that cools a heat source, wherein the projection optical unit includes a projection lens that enlarges and projects the modulated light from the imager, a reflection mirror that reflects the enlarged projection light from the projection lens onto the projection plane, wherein a gap is formed between the projection optical unit and the housing member by an optical axis passing a center of the imager being shifted with respect to an optical axis passing a center of the projection lens, and wherein a duct forming an airflow path of the cooling unit is provided in the gap.

In the eighth feature, the cooling unit further includes a draw-in unit that draw in cool air and a cooling unit that cools heat by using the cooling air. The draw-in unit and the cooling unit are provided adjacent to each other in a direction opposing to the projecting unit.

In the eighth feature, an inlet where the draw-in unit draws in the cool air and an outlet where the cooling unit draws out the cool air are each disposed at different surfaces of the housing member.

In the eighth feature, the projection display apparatus includes at least another cooling unit different from the cooling unit. One of the cooling unit and the another cooling unit cools a high temperature heat source, and the other of the cooling unit and the another cooling unit cools a low temperature heat source having lower temperature than that of the high temperature heat source.

### BRIEF DESCRIPTION OF THE DRAWINGS

FIG. 1 shows an outline of a projection display apparatus 100 according to a first embodiment.

FIG. 2 shows an outline of a projection display apparatus 100 according to the first embodiment.

FIG. 3 shows details of a projection display apparatus 100 according to the first embodiment.

FIG. 4 shows details of the projection display apparatus 100 according to the first embodiment.

FIG. 5 shows a configuration of an illumination optical unit 310 according to the first embodiment.

FIG. 6 shows a configuration of a heat pipe 340 according to the first embodiment.

FIG. 7 shows a layout space according to the first embodiment.

FIG. 8 shows an outline of a projection display apparatus 100 according to a second embodiment.

FIG. 9 shows an outline of a projection display apparatus 100 according to the second embodiment.

FIG. 10 shows details of a projection display apparatus 100 according to the second embodiment.

FIG. 11 shows details of a projection display apparatus 100 according to the second embodiment.

FIG. 12 shows details of a cooling unit 1430 according to the second embodiment.

FIG. 13 shows details of a cooling unit 1430 according to the second embodiment.

FIG. 14 shows details of a cooling unit 1430G according to the second embodiment.

FIG. 15 shows details of a cooling unit 1430B according to the second embodiment.

FIG. 16 shows an individual unit according to a modification example 1.

FIG. 17 shows an individual unit according to a modification example 1.

FIG. 18 shows an individual unit according to a modification example 1.

FIG. 19 shows a combination of a plurality of individual units according to a modification example 1.

FIG. 20 shows a combination of a plurality of individual units according to the modification example 1.

FIG. 21 shows a combination of a plurality of individual units according to the modification example 1.

FIG. 22 is a side view of a projection display apparatus 2100 (floor face projection) according to a third embodiment.

FIG. 23 is a side view of a projection display apparatus 2100 (wall face projection) according to the third embodiment.

FIG. 24 is a front view of a projection display apparatus 2100 according to the third embodiment.

FIG. 25 is a perspective view in which a front face of a projection display apparatus 2100 according to the third embodiment is viewed from a diagonally upward direction thereof.

FIG. 26 is a perspective view in which a bottom surface of a projection display apparatus 2100 according to the third embodiment is viewed from a diagonally downward direction thereof.

FIG. 27 shows details of a cooling unit 2400G and a cooling unit 2400B according to the third embodiment.

FIG. 28 shows details of a cooling unit 2700 according to the third embodiment.

FIG. 29 shows details of a projection optical unit 2050 according to the third embodiment.

FIG. 30 shows details of a second cooling unit 2720 according to the third embodiment.

FIG. 31 is a side view of a projection display apparatus 2100 (floor face projection) according to a fourth embodiment.

FIG. 32 is a side view of a projection display apparatus 2100 (wall face projection) according to the fourth embodiment.

FIG. 33 is a front view of a projection display apparatus 2100 according to the fourth embodiment

FIG. 34 is a perspective view in which a front face of a projection display apparatus 2100 according to the fourth embodiment is viewed from a diagonally upward direction thereof.

FIG. 35 is a perspective view in which a bottom surface of a projection display apparatus 2100 according to the fourth embodiment is viewed from a diagonally downward direction thereof.

FIG. 36 shows details of a cooling unit 2400G and a cooling unit 2400B according to the fourth embodiment.

FIG. 37 shows details of a cooling apparatus 2700 according to the fourth embodiment.

FIG. 38 shows details of a projection optical unit 2050 according to the fourth embodiment.

FIG. 39 shows details of a second cooling unit 2720 according to the fourth embodiment.

### MODES FOR CARRYING OUT THE INVENTION

A projection display apparatus according to embodiments of the present invention will be described with reference to the drawings herebelow. In description of the following drawings, same or similar reference numerals are applied to same or similar elements.

However, the Figs. are schematically drawn, and thus ratios of sizes should be different from real ones. Therefore, a specific size should be determined in consideration of following descriptions. Moreover, the drawings include portions having the different relationship and ratios of sizes.

### Outline of First Embodiment

First, a projection display apparatus the according to a first embodiment includes a housing member that accommodates an illumination optical unit, a projection optical unit, and a cooling unit The housing member includes a layout space in a virtually columnar shape including a bottom that is the circumscribed circle of the projection optical unit in a vertical cross sectional view with respect to the optical axis of the projection optical unit. The layout space includes the first layout space in a substantially conical shape and a second layout space excluding the first layout space. The projection optical unit is disposed in the first layout space. At least a part of the illumination optical unit and cooling unit is disposed in the second layout space. The illumination optical unit and the cooling unit are disposed in the symmetrical positional relationship with respect to the projection optical unit.

According to the first embodiment, the projection optical unit is provided in the first layout space in a substantially conical shape, and at least a part of the illumination optical unit and the cooling unit is disposed in a dead space (second layout space) generated by an arrangement of the projection optical unit in the housing member. More specifically, since the dead space is effectively used, the illumination optical unit, the projection optical unit, and the cooling unit can be disposed in a space-saving manner.

According to the first embodiment, the illumination optical unit and the cooling unit are disposed in a symmetrical positional relationship with respect to the projection optical unit. Therefore, the projection optical unit can be disposed at the center of the housing member.

Secondly, the projection display apparatus includes the housing member that accommodates the illumination optical unit, the projection optical unit, and the cooling unit. In the front view of the housing member, the illumination optical unit and the cooling unit are disposed in a symmetrical positional relationship with respect to the projection optical unit. In the side view of the housing member, the illumination optical unit and the cooling unit are disposed to overlap the projection optical unit.

According to the embodiment, the illumination optical unit and the cooling unit are disposed in a symmetrical positional relationship with respect to the projection optical unit in the front view of the housing member. In the side view of the housing member, the illumination optical unit and the cooling unit are disposed to overlap the projection optical unit. Therefore, the illumination optical unit, the projection optical unit, and the cooling unit can be disposed in a space-saving manner, while disposing the projection optical unit at the center of the housing member.

### First Embodiment

### (Outline of Projection Display Apparatus)

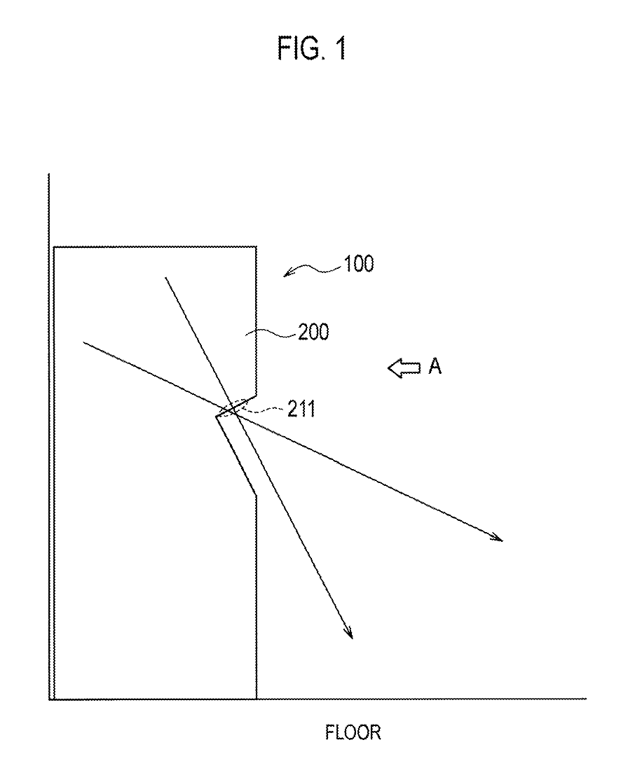

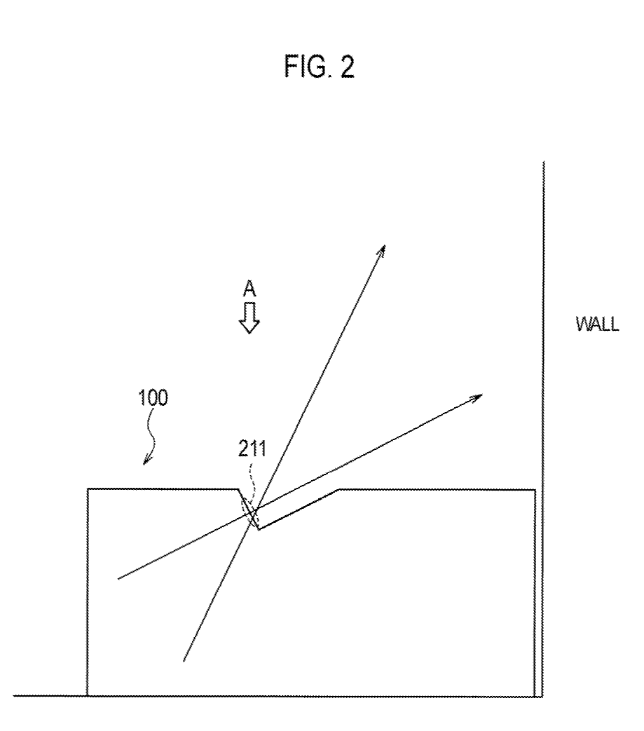

The outline of the projection display apparatus according to the first embodiment is described with reference to the drawings as follows. FIG. 1 shows the projection display apparatus 100 (floor face projection) according to the first embodiment. FIG. 2 shows the projection display apparatus 100 (wall face projection) according to the first embodiment.

As shown in FIG. 1 and FIG. 2, the projection display apparatus 100 includes the housing member 200, and projects an image on a projection plane (not shown in the figure). The projection plane may be provided on the floor face as shown in FIG. 1, and also may be provided on the wall face as shown in FIG. 2. A transparent region 211 through which image light passes is provided in the housing member 200.

### (Details of Projection Display Apparatus)

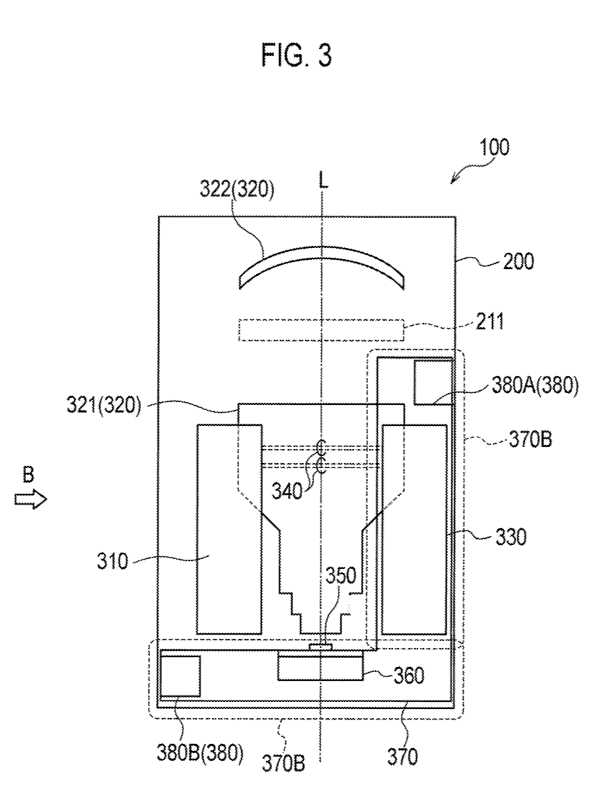

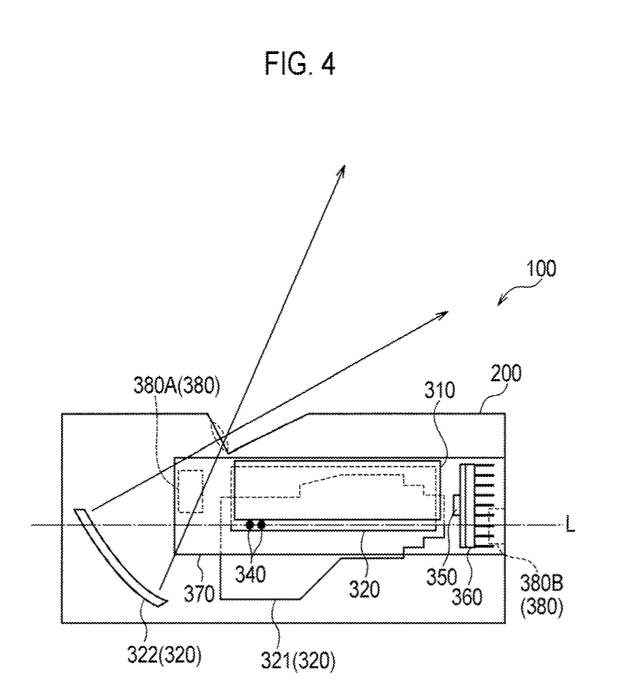

The details of the projection display apparatus according to the first embodiment will be described with reference to the drawings as follows. FIG. 3 and FIG. 4 show the details of the projection display apparatus 100. FIG. 3 (front view) shows the projection display apparatus 100 from an A direction as shown in FIG. 1 and FIG. 2. FIG. 4 (side view) shows the projection display apparatus 100 from a B direction as shown in FIG. 3. In FIG. 3 and FIG. 4, viewing through the housing member 200, an internal configuration of the projection display apparatus 100 is shown.

As shown in FIG. 3 and FIG. 4, the projection display apparatus 100 includes an illumination optical unit 310, a projection optical unit 320, a cooling apparatus 330, a heat pipe 340, a digital micro mirror device (DMD) 350, a heat sink 360, a duct 370, and a fan 380.

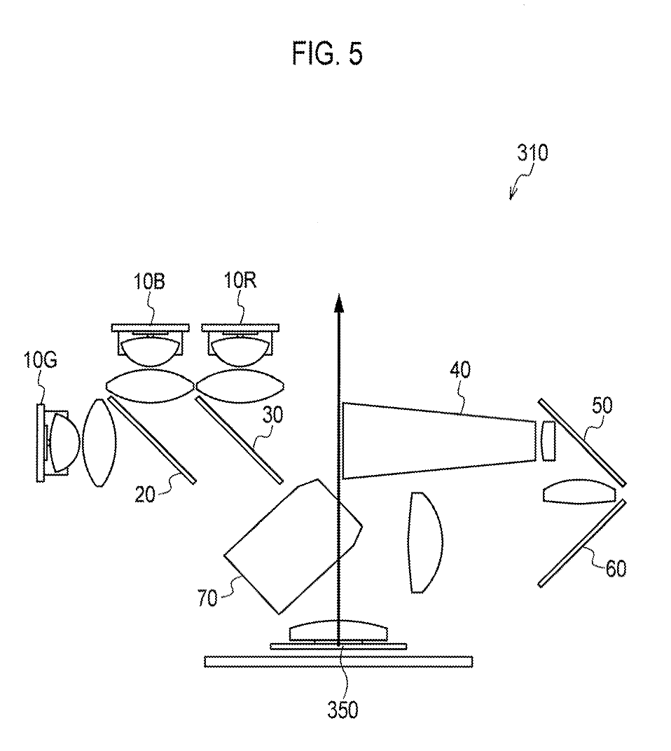

The illumination optical unit 310 includes a light source as described below, and emits the light to be irradiated to the DMD 350. The details of the illumination optical unit 310 are described herebelow (refer to FIG. 5).

The projection optical unit 320 projects the image light emitted from the DMD 350 onto the projection plane. For example, the projection optical unit 320 includes a projection lens group 321 and a reflection mirror 322.

The projection lens group 321 emits the image light emitted from the DMD 350 onto the reflection mirror 322. The projection lens group 321 includes a lens having a substantially round shape about an optical axis L of the projection optical unit 320 and a lens having a part of a shape in a substantially round shape (e.g., hemicycle shape of the lower half) about the optical axis L of the projection optical unit 320.

A diameter of the lens included in the projection optical unit 320 is larger as getting closer to the reflection mirror 322.

The reflection mirror 322 reflects the image light emitted from the DMD 350 onto the projection plane side. The reflection mirror 322 is, for example, an aspheric mirror that includes a concave surface at the DMD 350 side.

The cooling apparatus 330 has a function for cooling a heat source of the illumination optical unit 310 (e.g., light source). More specifically the cooling apparatus 330 draw in the heat generated by the heat source of the illumination optical unit 310 through the heat pipe 340. For example, the cooling apparatus 330 is a heat cooling member such as a heat sink.

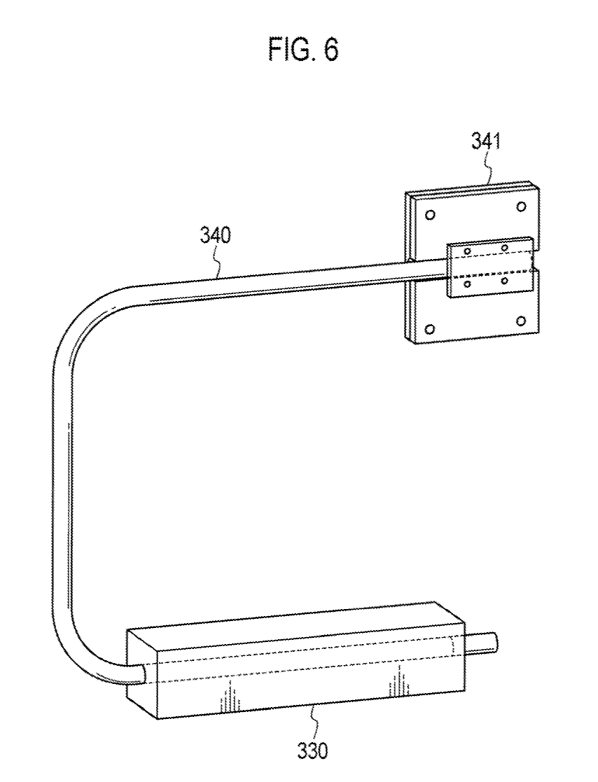

The heat pipe 340 is a pipe for transmitting the heat generated by the heat source of the illumination optical unit 310 (e.g., light source) to the cooling apparatus 330. The heat pipe 340 is formed of material (e.g., copper) having a high temperature conductivity. The details of the heat pipe 340 are described herebelow (refer to FIG. 6).

The DMD 350 is formed of a plurality of minute mirrors, which can be moved. The DMD 350 switches whether to reflect the light emitted from the illumination optical unit 310 by changing an angle of each minute mirror.

Herein, a center of the DMD 350 is shifted from the optical axis L of the projection optical unit 320 as shown in FIG. 4. More specifically, the center of the DMD 350 is shifted from optical axis L of the projection optical unit 320 to the projection plane side.

The heat sink 360 is a cooling member for cooling the DMD 350.

The duct 370 forms the airflow path for leading the heat generated by the DMD 350 to the outside of the housing member 200. Moreover, according to the first embodiment, the duct 370 forms the airflow path for leading the heat to the outside of the housing member 200 by the cooling apparatus 330.

In other words, the duct 370 has both functions for leading the heat generated by the DMD 350 to the outside of the housing member 200, and the heat generated by the heat source of the illumination optical unit 310 to the outside of the housing member 200. The cooling apparatus 330 and the heat sink 360 described above are disposed in the duct 370.

The fan 380 forms the airflow from the upper side to the lower side in the airflow path formed of the duct 370. More specifically, the fan 380 includes a fan 380A and a fan 380B.

The fan 380A leads the air to the outside of the housing member 200 into the duct 370. The fan 380A is disposed at an upper portion of the housing member 200 (duct 370) as shown in FIG. 3. On the other side, the fan 380B leads the air in the duct 370 outside the housing member 200. The fan 380B is disposed at a lower portion of the housing member 200 (duct 370) as shown in FIG. 3.

Thus, the airflow from the upper side to the lower side is formed of the fan 380A and fan 380B. However, the fan 380A and the fan 380B are not necessarily needed. Either one of the fan 380A and the fan 380B may be provided.

According to the first embodiment as shown in FIG. 3, the illumination optical unit 310 and the cooling apparatus 330 are preferably disposed in the symmetrical positional relationship with respect to the projection optical unit 320 in the front view of the housing member 200. Moreover, as shown in FIG. 4, the illumination optical unit 310 and the cooling apparatus 330 preferably overlap the projection optical units 320 in the side view of the housing member 200.

### (Configuration of Illumination Optical Unit)

A configuration of the illumination optical unit according to the first embodiment is described with reference to the drawings as follows. FIG. 5 shows a configuration of the illumination optical unit 310 according to the first embodiment.

As shown in FIG. 5, the illumination optical unit 310 includes light sources 10 (light source 10R, light source 10G, and light source 10B), a dichroic mirror 20, a dichroic mirror 30, a rod integrator 40, a reflection mirror 50, a reflection mirror 60, and a launch mirror 70.

The light source 10R emits red component light R, and is a red LED (Light Emitting Diode) or a red LD (laser diode), for example. The light source 10G emits green component light G, and is a green LED or a green LD, for example. The light source 10B emits blue component light B, and is a blue LED or blue LD, for example.

The dichroic mirror 20 transmits the green component light G emitted from the light source 10G, and reflects the blue component light B emitted from the light source 10B. The dichroic mirror 30 transmits the green component light G and the blue component light B, and reflects the red component light R emitted from light source 10R.

A rod integrator 40 includes a light incident surface, a light emitting surface, and a light reflection side surface provided from a periphery of the light incident surface to a periphery of the light emitting surface. The rod integrator 40 uniformizes the color component light emitted from the light source 10 (light source 10R, light source 10G, and light source 10B).

The reflection mirror 50 and the reflection mirror 60 reflect the color component light emitted from the rod integrator 40, and lead the color component light emitted from the rod integrator 40 to the launch mirror 70.

The launch mirror 70 reflects the color component light led by the reflection mirror 50 and the reflection mirror 60 to the DMD 350 side.

### (Configuration of Heat Pipe)

The heat pipe according to the first embodiment will be described as follows. FIG. 6 shows a configuration of the heat pipe 340 according to the first embodiment.

As shown in FIG. 6, an end of the heat pipe 340 is connected to the cooling apparatus 330. On the other hand, a heat receiving portion 341 connected to the heat source (e.g., light source 10) of the illumination optical unit 310 is provided for the heat pipe 340.

As a result, the heat receiving portion 341 receives the heat generated by the heat source of the illumination optical unit 310, and the heat received by the heat receiving portion 341 is transmitted to the cooling apparatus 330 through the heat pipe 340.

### (Layout Space)

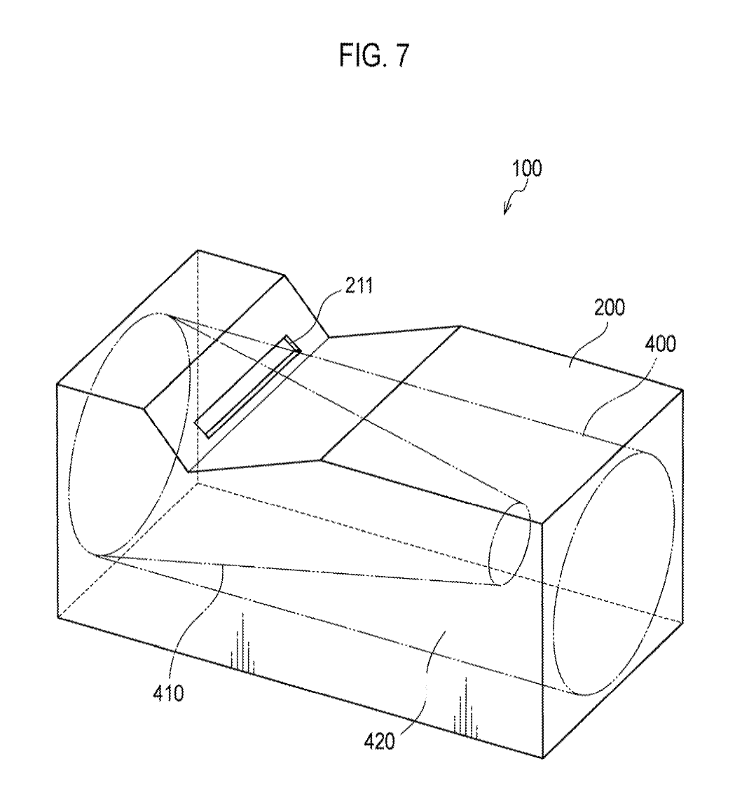

The layout space according to the first embodiment will be described with reference to the drawing as follows. FIG. 7 shows the layout space 400 according to the first embodiment.

As shown in FIG. 3, the housing member 200 includes the layout space 400 formed of the first layout space 410 and the second layout space 420.

The layout space 400 has a virtually columnar shape that includes as a bottom the circumscribed circle of the projection optical unit 320 in a vertical cross sectional plane with respect to the optical axis L of the projection optical unit 320. The bottom of the layout space 400 includes the optical axis L of the projection optical unit 320 as a center thereof. The bottom of the layout space 400 is a circumscribed circle of a portion (e.g., reflection mirror 322) protruding most outside in a vertical cross sectional plane with respect to the optical axis L of the projection optical unit 320 among the projection optical unit 320.

The first layout space 410 has a substantially conical shape. More specifically, the first layout space 410 has an end-winding shape from the DMD 350 side toward the reflection mirror side 322.

The projection optical unit 320 is provided in the first layout space 410. The projection optical unit 320 may be disposed so that the whole of projection optical unit 320 is included completely in the first layout space 410, and may be disposed so that a part of the projection optical unit 320 is disposed out of the first layout space 410.

The second layout space 420 is acquired by excluding the first layout space 410 from the layout spaces 400. A capacity of the second layout space 420 becomes larger from the reflection mirror side 322 toward the DMD 350 side.

At least a part of the illumination optical unit 310 and the cooling apparatus 330 is disposed in the second layout space 420. For example, the rod integrator 40, among the optical elements included in the illumination optical unit 310, is disposed in the second layout space 420.

Herein, the illumination optical unit 310 and the cooling apparatus 330 are disposed in the symmetrical positional relationship with respect to the projection optical unit 320. More specifically, in a vertical direction, a horizontal direction, and a diagonal direction, the illumination optical unit 310 and the cooling apparatus 330 are disposed in a symmetrical relationship with respect to the projection optical unit 320.

In the front view of the housing member 200, the illumination optical unit 310 and the cooling apparatus 330 are preferably disposed in a symmetrical relationship with respect to the projection optical unit 320. Moreover, in the side view of the housing member 200, the illumination optical unit 310 and the cooling apparatus 330 are preferably disposed to overlap the projection optical units 320.

### (Operation and Effect)

According to the first embodiment, the projection optical unit 320 is provided in the first layout space in a substantially conical shape, and at least a part of the illumination optical unit 310 and the cooling apparatus 330 is disposed in the dead space (second layout space) generated by the arrangement of the projection optical unit 320 in the housing member 200. More specifically, since the dead space is effectively used, the illumination optical unit 310, the projection optical unit 320, and the cooling apparatus 330 can be disposed in a space-saving manner.

According to the first embodiment, the illumination optical unit 310 and the cooling apparatus 330 are disposed in a symmetrical relationship with respect to the projection optical unit 320. Therefore, the projection optical unit 320 can be disposed at the center of the housing member 200.

According to the first embodiment, in the front view of the housing member 200, the illumination optical unit 310 and the cooling apparatus 330 are disposed in a symmetrical relationship with respect to the projection optical unit 320. In the side view of the housing member 200, the illumination optical unit 310 and the cooling apparatus 330 are disposed to overlap the projection optical unit 320. Therefore, the illumination optical unit 310, the projection optical unit 320, and the cooling apparatus 330 are disposed in a space-saving manner while disposing the projection optical unit 320 at the center of the housing member 200.

According to the first embodiment, the cooling apparatus 330 is connected to the illumination optical unit 310 through the heat pipe 340. Therefore, the cooling apparatus 330 can be disposed more freely.

According to the first embodiment, the duct 370 has both functions for leading the heat generated by the DMD 350 to the outside of the housing member 200 and leading the heat generated by the heat source of the illumination optical unit 310 to the outside of the housing member 200. Therefore, the airflow path formed of the duct 370 can be simplified.

According to the first embodiment, the fan 380 forms the airflow from the upper side to the lower side in the airflow path formed of the duct 370. Therefore, the air in the airflow path can effectively go outside the housing member 200.

### Outline of Second Embodiment

Conventional projection optical units have been known that includes the projection optical unit for projecting the light emitted from the illumination optical unit on the projection plane. The illumination optical unit includes the light source such as the LED and the imager for modulating the light emitted from the light source. Moreover, the projection display apparatus includes the cooling unit such as the heat sink that cools the heat source of the light source.

In such a case, the cooling unit is disposed in the airflow path of the cooling air flowing from the inlet to the outlet. In order to apply the cooling air to the outlet, a cover for covering the cooling unit is provided (e.g., JP, 2007-13052).

However, when the cover for covering the cooling unit is provided, the layout space of the cooling unit is limited, and thus the projection display apparatus that includes the cooling unit is increased in size.

A cooling unit according to the second embodiment includes the plurality of cooling fins connected to the heat pipe, and disposed at the predetermined interval along the direction in which the heat pipe extends. The cooling fins include a fin body in a plate shape including the main surface vertical to the direction in which the heat pipe extends and the airflow guiding wall including the airflow guiding surface vertical to the main surface. The airflow guiding wall is provided to lead the cooling air supplied to the plurality of cooling fins into the different direction.

According to the second embodiment, the airflow guiding wall is provided to lead the cooling air supplied to the plurality of cooling fins into the different direction. Therefore, the cooling air can be led in a desired direction by a simple configuration.

### Second Embodiment

### (Outline of Projection Display Apparatus

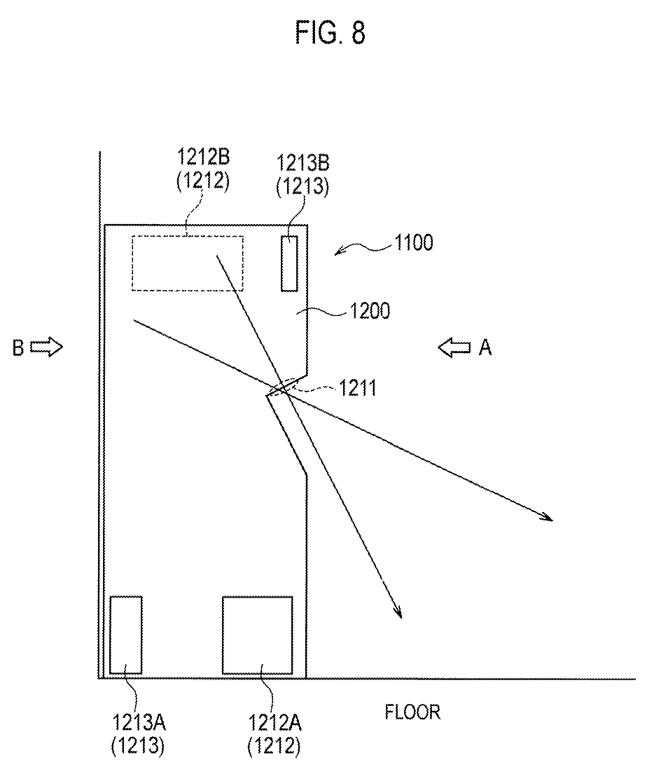

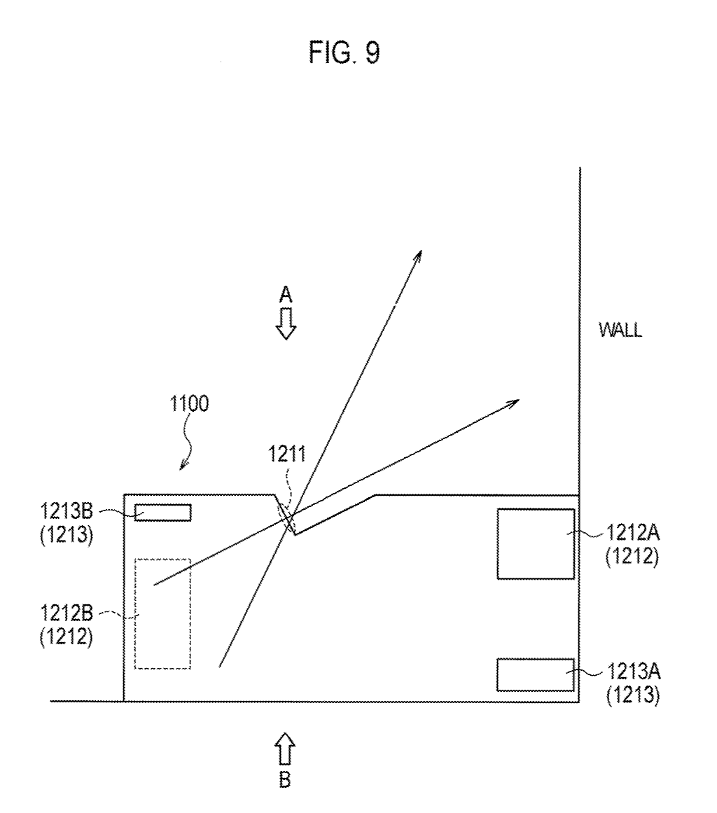

An outline of the projection display apparatus according to the second embodiment will be described with reference to the drawings as follows. FIG. 8 shows the projection display apparatus 1100 (floor face projection) according to the second embodiment. FIG. 9 shows the projection display apparatus 1100 (wall face projection) according to the second embodiment.

As shown in FIG. 8 and FIG. 9, the projection display apparatus 1100 includes the housing member 1200, and projects an image onto the projection plane (not shown in the figure). As shown in FIG. 8, the projection plane may be provided on the floor face or, as shown in FIG. 9, it may be provided on the wall face.

A transparent region 1211 through which the image light passes is provided on the housing member 200. Inlets 1212 (inlet 1212A and inlet 1212B) and outlets 1213 (outlet 1213A and outlet 1213B) are provided for the housing member 200.

### (Details of Projection Display Apparatus)

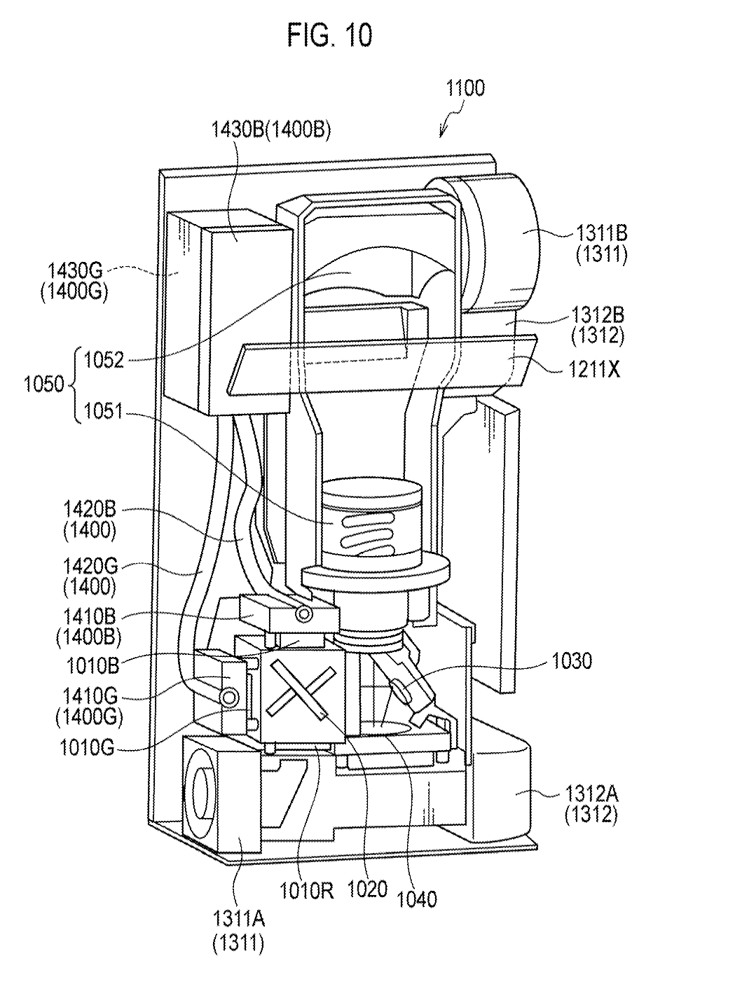

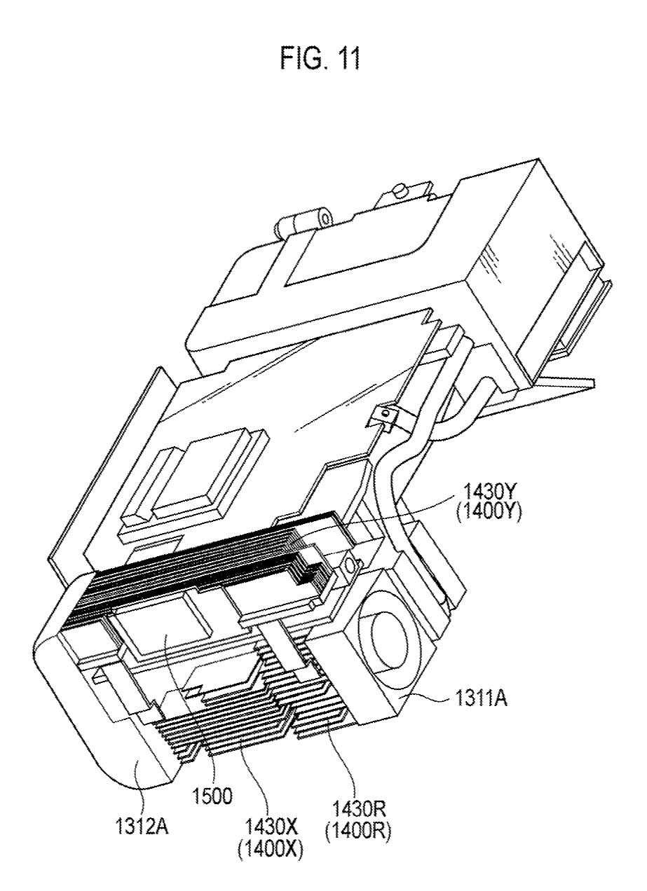

Details of the projection display apparatus according to the second embodiment will be described with reference to the drawings as follows. FIG. 10 and FIG. 11 show the details of the projection display apparatus 100. FIG. 10 is a perspective view (front view) in which the projection display apparatus 100 is viewed from the A direction shown in FIG. 1 and FIG. 9. FIG. 11 is a perspective view (rear view) in which the projection display apparatus 100 is viewed from the B direction shown in FIG. 10. In FIG. 10 and FIG. 11, viewing through the housing member 200, an internal configuration of the projection display apparatus 100 is shown.

As shown in FIG. 10 and FIG. 11, the projection display apparatus 100 includes light sources 1010 (light source 1010R, light source 1010G, and light source 1010B) and a cross dichroic mirror 1020, a turning mirror 1030, a DMD 1040, and a projection optical units 1050.

The light source 10R emits the red component light R, for example, the red LED and red LD. The light source 10G emits the green component light G, for example, the green LED and the green LD. The light source 10B emits the blue component light B, for instance, the blue LED and the blue LD.

The dichroic mirror 20 transmits the green component light G emitted from light source 10G, and reflects the blue component light B emitted from the light source 10B. Moreover, the dichroic mirror 20 transmits the green component light G, and reflects the red component light R emitted from the light source 10R.

The launch mirror 70 reflects the color component light emitted from the dichroic mirror 20 to the DMD 350 side.

The DMD 350 is formed of the plurality of minute mirrors, which are a movable type. The DMD 350 switches whether to reflect the light reflected by the launch mirror 70 to the projection optical unit 320 by changing the angle of each minute mirror.

Herein, the center of the DMD 350 is shifted from the optical axis of the projection optical unit 320. More specifically, the center of the DMD 350 is shifted in the B direction (i.e., at a side of an area where the image light is projected) shown in FIG. 9 from the optical axis of the projection optical unit 320.

The projection optical unit 320 projects the image light emitted from the DMD 350 onto the projection plane. For example, the projection optical unit 320 includes the projection lens group 1051 and the reflection mirror 1052.

The projection lens group 321 projects the image light emitted from the DMD 350 onto the reflection mirror 322 side. The projection lens group 321 includes the lens having a substantially round shape about the optical axis L of the projection optical unit 320 and the lens having a part of a shape in a substantially round shape (e.g., hemicycle shape of a lower half) about the optical axis L of the projection optical unit 320.

The diameter of the lens included in the projection optical unit 320 is larger as getting closer to the reflection mirror 322.

The reflection mirror 322 reflects the image light emitted from the DMD 350 onto the projection plane side. The reflection mirror 322 is, for example, the aspheric mirror that includes a concave surface at the DMD 350 side.

Returning to FIG. 10 and FIG. 11, the protection display apparatus 100 includes fans 1311 (fan 1311A, fan 1311B) and ducts 1312 (duct 1312A and duct 1312B).

The fan 380 forms the airflow from the inlet 1212 to the outlet 1213 in the airflow path formed of the duct 370. More specifically, the fan 380A leads the air to the outside of the housing member 200 from the inlet 1212A into the duct 1312A. The fan 380B leads the air to the outside of the housing member 200 from the inlet 1212A into the duct 1312B.

The duct 370 forms the airflow path from the inlet 1212 to the outlet 1213. The duct 370 may form only a part of the airflow path. More specifically, the duct 1312A forms the airflow path from the inlet 1212A to the outlet 1213A. Further, the duct 1312B forms the airflow path from the inlet 1212B to the outlet 1213B.

The projection display apparatus 100 includes cooling units 1400 (cooling unit 1400R, cooling unit 1400G, cooling unit 1400B, cooling unit 1400X, and cooling unit 1400Y).

The cooling unit 1400R cools the light source 10R. According to the second embodiment, the cooling unit 1400R refers to the cooling fins 1430R.

The cooling unit 1400G cools the light source 10G. The cooling unit 1400B cools the light source 10B. The cooling unit 1400G and the cooling unit 1400B include heat receiving portions 1410 (heat receiving portion 1410G and heat receiving portion 1410B), heat pipes 1420 (heat pipe 1420G and heat pipe 1420B), and cooling fins 1430 (cooling fins 1430G and cooling fins 1430B).

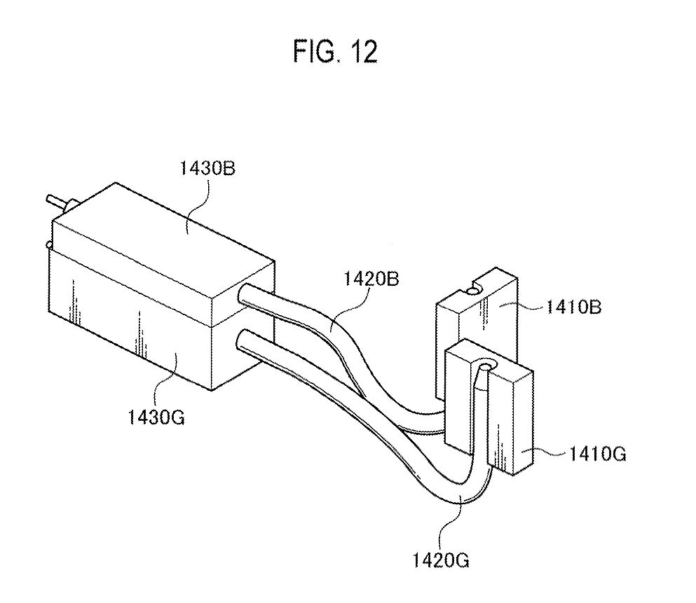

The cooling unit 1400G and the cooling unit 1400B are one example of the cooling unit according to this specification. The details of the cooling unit 1400G and the cooling unit 1400B are described below (refer to FIG. 12).

The cooling unit 1400X cools the DMD 350. According to the second embodiment, the cooling unit 1400X refers to the cooling fins 1430X.

The cooling unit 1400Y cools the driver base plate 1500 (refer to FIG. 11) that drives the light source 10. According to the second embodiment, the cooling unit 1400Y refers to the cooling fins 1430Y.

### (Details of Cooling Unit)

The details of the cooling unit according to the second embodiment will be described with reference to the drawings as follows. FIG. 12 shows the details of the cooling unit 1400 according to the second embodiment.

The cooling units 1400 (cooling unit 1400G, cooling unit 1400B) include a heat receiving portion 1410, a heat pipe 1420, and cooling fins 1430 as shown in FIG. 12.

The heat receiving portion 1410 receives the heat from the heat source. The heat pipe 1420 transmits the heat to the cooling fins 1430. The cooling fins 1430 are disposed on the airflow path for the cooling air.

More specifically, the heat receiving portion 1410G receives the heat of the light source 10G, and then the heat pipe 1420G transmits the heat of the light source 10G to the cooling fins 1430G. The heat receiving portion 1410B similarly receives the heat of the light source 10B, and the heat pipe 1420B transmits the heat of the light source 10B to the cooling fins 1430B.

Herein, each cooling unit 1400 includes the plurality of cooling fins 1430. The plurality of cooling fins 1430 are connected to the heat pipe 1420, and disposed at the predetermined interval along the direction in which the heat pipe 1420 runs.

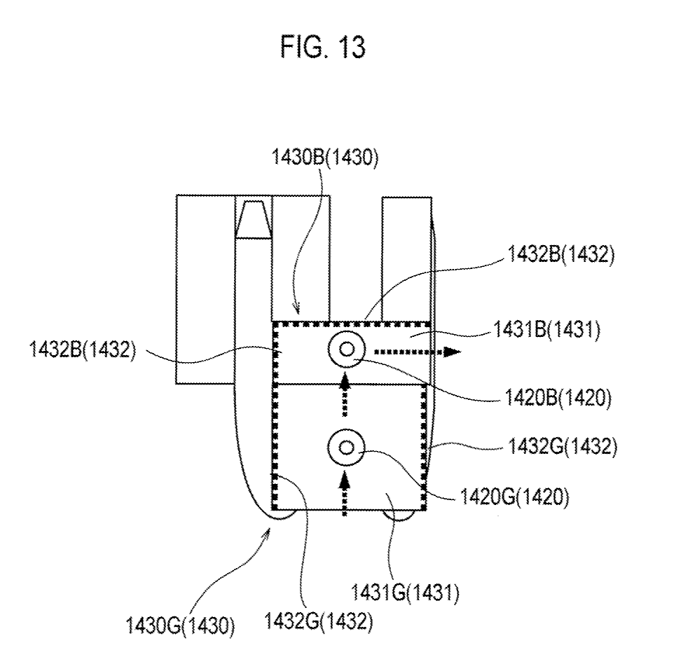

More specifically, the cooling fins 1430 (cooling fins 1430G and cooling fins 1430B) includes the fin bodies 1431 (fin body 1431G and fin body 1431B) and cooling fins 1432 (airflow guiding wall 1432G and airflow guiding wall 1432B) as shown in FIG. 13.

The fin body 1431 has a plate shape and includes the main surface vertical to the direction in which the heat pipe 1420 runs. The airflow guiding wall 1432 includes the airflow guiding surface vertical to the main surface of the fin body 1431.

According to the second embodiment, the airflow guiding wall 1432 is provided to lead the cooling air (i.e., the cooling air supplied to the cooling fins 1430) flowing in the airflow path into the different direction.

According to the second embodiment, the main surface of the fin body 1431 has a rectangular shape. The airflow guiding wall 1432 is provided along the two sides that are adjacent to each other on the main surface of the fin body 1431 (e.g., cooling fins 1430B shown in FIG. 13).

The “main surface” refers to a surface having the largest area of the surfaces of the fin body 1431. The fin body 1431 includes a pair of main surfaces to have a plate shape.

When the cooling unit 1400G and the cooling unit 1400B are considered to be one cooling unit 1400, each of the cooling unit 1400G and the cooling unit 1400B are included in an individual unit. In such a case, the cooling fins 1430G and the cooling fins 1430B are disposed adjacent to each other at the interval on the airflow path formed of the airflow guiding wall 1432.

The calorific amount of the light source 10G is larger than the calorific amount of the light source 10B. Therefore, the cooling unit 1400G and the cooling unit 1400B are disposed to lead the cooling air from the cooling unit 1400G (cooling fins 1430G) to the cooling unit 1400B (cooling fins 1430B).

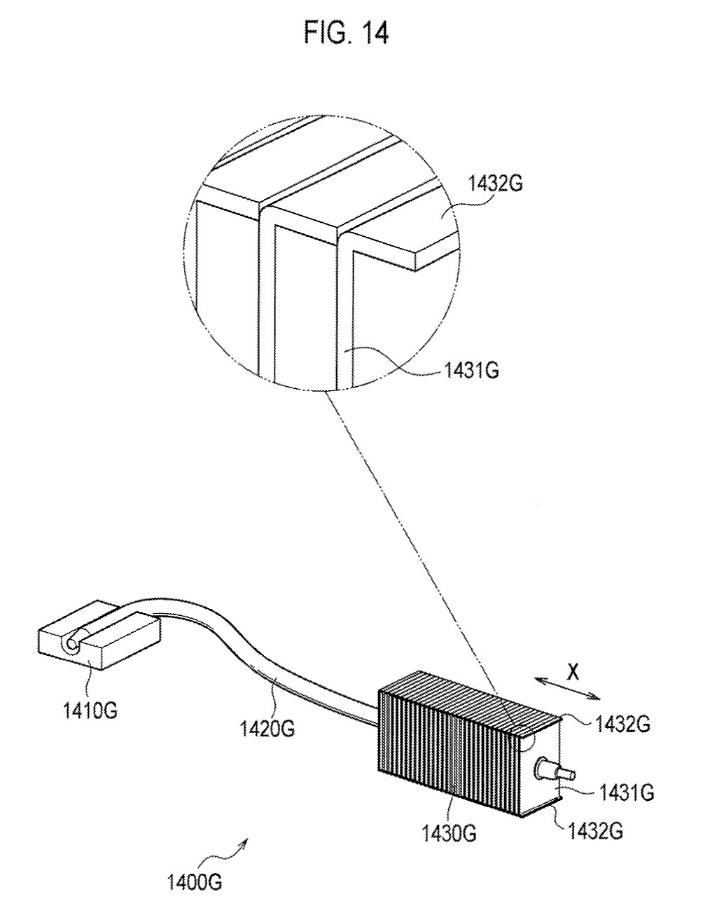

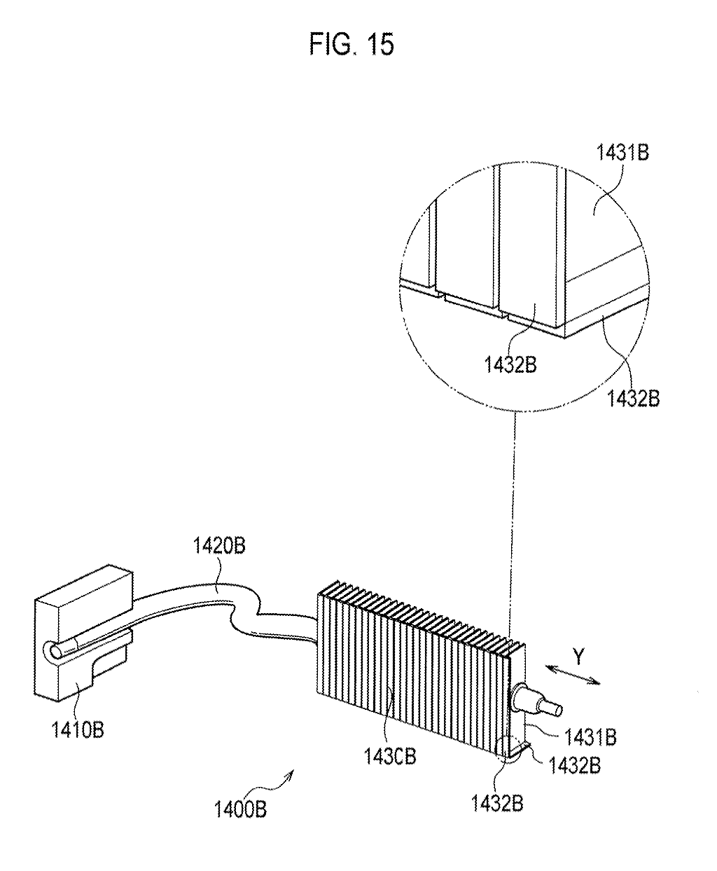

More details of the cooling unit 1400G and the cooling unit 1400B will be described as follows. FIG. 14 shows the cooling unit 1400G according to the second embodiment. FIG. 15 shows the cooling unit 1400B according to the first embodiment.

As shown in FIG. 14, the cooling unit 1400G includes the heat receiving portion 1410G, the heat pipe 1420G, and the cooling fins 1430G. Moreover, the cooling fins 1430G include the fin body 1431G and the airflow guiding wall 1432G.

The fin body 1431G includes a plate shape vertical to an X direction in which the heat pipe 1420G runs. The airflow guiding wall 1432G has a shape protruding along the X direction in which the heat pipe 1420G runs from the fin body 1431G. In other words, the airflow guiding wall 1432G includes the airflow guiding surface vertical to the main surface of the fin body 1431G.

For example, the airflow guiding wall 1432G may be formed integrally with the fin body 1431G as shown in FIG. 14. In other words, the airflow guiding wall 1432G may be formed by bending the tubular plate.

Alternately, the airflow guiding wall 1432G may be formed as another body separated from the fin body 1431G. In such a case, the airflow guiding wall 1432G of the plurality of cooling fins 1430G disposed along the X direction in which the heat pipe 1420G runs may be formed of a piece of tabular plate. The piece of tabular plate forming the airflow guiding wall 1432G is bonded to the side surface of the fin body 1431G of the plurality of cooling fins 1430G disposed along the X direction in which the heat pipe 1420G runs.

As shown in FIG. 15, the cooling unit 1400B includes the heat receiving portion 1410B, the heat pipe 1420B, and the cooling fins 1430B. Moreover, the cooling fins 1430B include the fin body 1431B and the airflow guiding wall 1432B.

The fin body 1431B has the plate shape vertical to a Y direction in which the heat pipe 1420B runs. The airflow guiding wall 1432B has a shape protruding along the Y direction in which the heat pipe 1420B runs from the fin body 1431B. In other words, the airflow guiding wall 1432B has the airflow guiding surface vertical to the main surface of the fin body 1431B.

For example, the airflow guiding wall 1432B may be formed integrally with the fin body 1431B as shown in FIG. 14. More specifically, the airflow guiding wall 1432B may be formed by bending the tabular plate.

Alternately, the airflow guiding wall 1432B may be formed as another body separated from the fin body 1431B. In such a case, the airflow guiding wall 1432B of the plurality of cooling fins 1430B disposed along the Y direction in which the heat pipe 1420B runs may be formed of a piece of tabular plate. The piece of tabular plate forming the airflow guiding wall 1432B is bonded to the side surface of the fin body 1431B of the plurality of cooling fins 1430B disposed along the Y direction in which the heat pipe 1420B runs.

### (Operation and Effect)

According to the second embodiment, the airflow guiding wall 1432 is provided to lead the cooling air supplied to the plurality of cooling fins 1430 into the different direction. Therefore, the cooling air can be led into the desired direction by a simple configuration.

According to the second embodiment, the cooling fins 1430G and the cooling fins 1430B are disposed adjacent to each other at the interval on the airflow path formed of the airflow guiding wall 1432. Therefore, transmitting to the cooling fin 1430B the heat generated by the light source 10G is reduced, and transmitting to the cooling fins 1430G the heat generated by the light source 10B is reduced. As a result, uniforming the temperature of the cooling fins 1430G and the cooling fins 1430B is reduced, thereby improving efficiency of cooling the cooling fins 1430 with the cooling air.

According to the second embodiment, the cooling air is led from the cooling unit 1400G that cools the light source 10G having the relatively large calorific amount to the cooling unit 1400B that cools the light source 10B having the relatively small calorific amount. Therefore, the efficiency of the cooling fins 1430 with the cooling air improves.

### Modification Example 1

The first modification example of the second embodiment will be described as follows. The difference from the second embodiment will be mainly described as follows.

More specifically, in the first modification example, a variation of the cooling fins 1430 will be described. In the first modification example, a case of a fin body 1431 including main surfaces with sides A to Z and having a rectangular shape will be described.

### (One Individual Unit)

Herein, one individual unit will be described. In other words, a case of the cooling unit 1400 including one individual unit will be described.

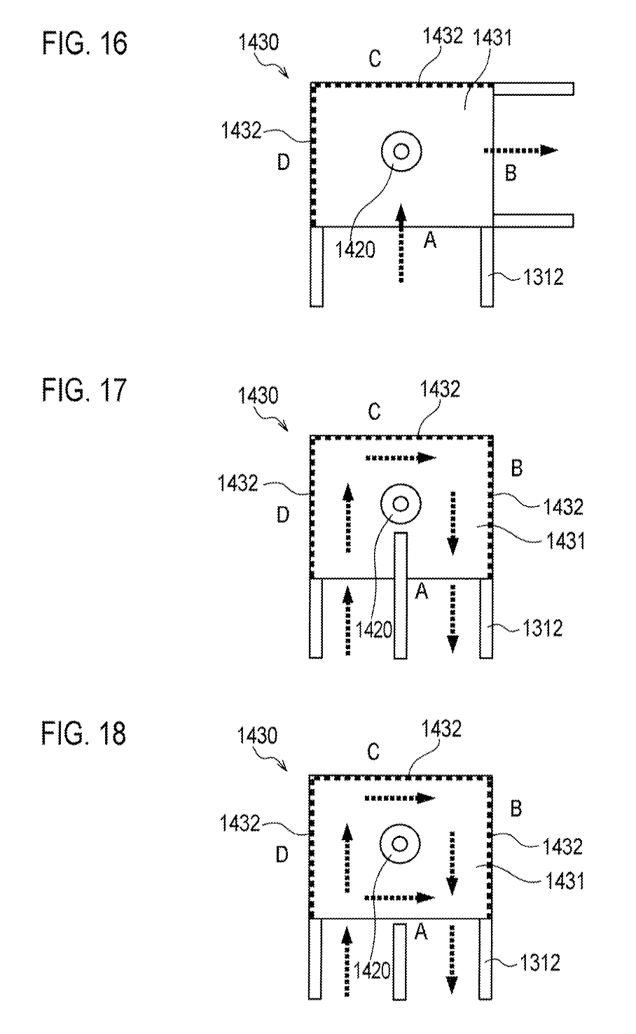

For example, as shown in FIG. 16, the cooling fins 1430 include the airflow guiding wall 1432 provided along the side C and the side D. The cooling air flows in through the side A, and the cooling air flows out through the side B. As a result, the cooling air can be led into the different direction.

Alternately, the cooling fins 1430 include the airflow guiding wall 1432 provided along the side B to the side D as shown in FIG. 17. The duct 370 provided for the side A reaches the heat pipe 1420, and the cooling air flows in through the side A, and the cooling air flows out through the side A. As a result, the cooling air can be led into the different direction. The cooling air passes closer to the side C than the heat pipe 1420.

Alternately, as shown in FIG. 18, the cooling fins 1430 include the airflow guiding wall 1432 provided along the side B to the side D. The duct 370 provided for the side A doesn't reach the heat pipe 1420, and the cooling air flows in through the side A, and the cooling air flows out therethrough. As a result, the cooling air can be led into the different direction. The cooling air passes closer to the side A and the side C than the heat pipe 1420.

### (Plurality of Individual Unit)

A combination of the plurality of individual units will be described herein. More specifically, the cooling unit 1400 including the plurality of individual unit will be described.

The cooling fins 1430 provided in the individual unit are preferably disposed adjacent to each other at the above-described interval.

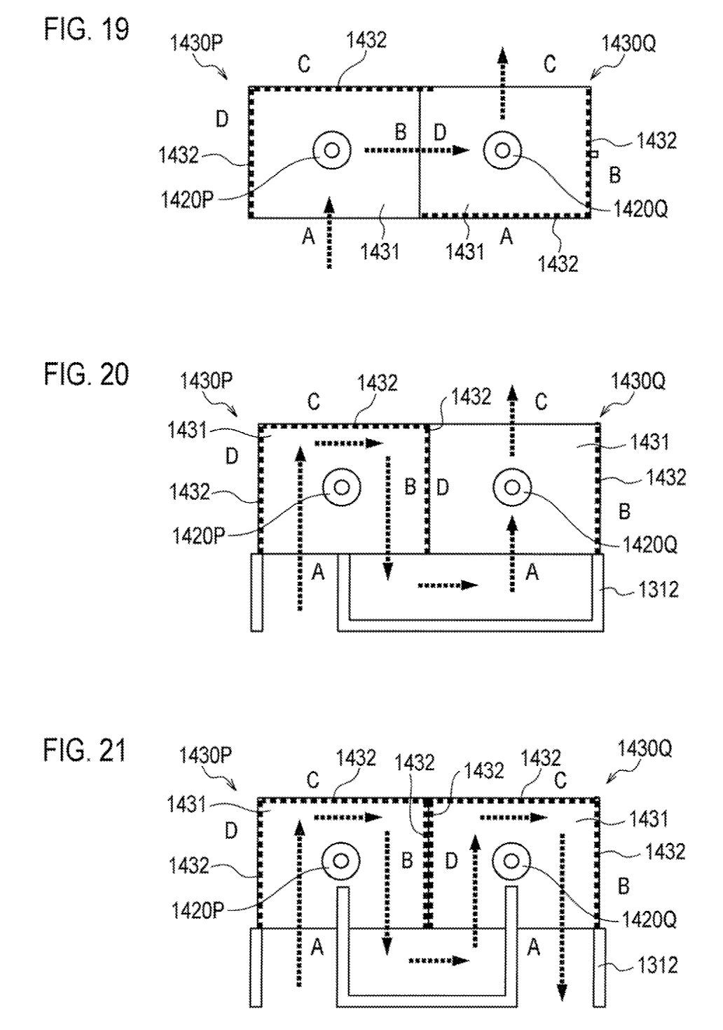

As shown in FIG. 19, the cooling fins 1430P include the airflow guiding wall 1432 provided along the side C and the side D. The cooling fins 1430Q include the airflow guiding wall 1432 provided along the side A and the side B. The cooling air flows in from the side A of the cooling fins 1430P, and the cooling air flows out from the side C of the cooling fins 1430Q. As a result, the cooling air can be led into the different direction.

Alternately, as shown in FIG. 20, the cooling fins 1430P include the airflow guiding wall 1432 provided along the side B to the side D. The cooling fins 1430Q include the airflow guiding wall 1432 provided along the side B. The cooling air flows in through the side A of the cooling fins 1430P, the cooling air flows in through the duct 370 to the side C of the cooling fins 1430Q, and then the cooling air flows out through the side C of the cooling fins 1430Q. As a result, the cooling air can be led into the different direction.

Alternately, the cooling fins 1430P include the airflow guiding wall 1432 provided along the side B to the side D. The cooling fins 1430Q include the airflow guiding wall 1432 provided along the side B to the side D. Moreover, the duct 370 reaches the heat pipe 1420P and the heat pipe 1420Q, and leads the cooling air that flows out through the side A of the cooling fins 1430P to the side A of the cooling fins 1430Q. The cooling air flows in through the side A of the cooling fins 1430P, the cooling air flows in through the duct 370 to the side A of the cooling fins 1430Q, and then the cooling air flows out through the side A of the cooling fins 1430Q. As a result, the cooling air can be led into the different direction.

### Outline of Third Embodiment

Conventional illumination optical units have been known that includes the projection optical unit for projecting the light emitted from the illumination optical unit onto the projection plane. The illumination optical unit includes the light source such as the LED and the imager that modulates the light emitted from the light source. The projection optical unit includes the projection lens for projecting the modulated light from the illumination optical unit onto the screen. Moreover, the projection display apparatus includes the cooling unit such as the heat sink that cools the heat source of the light source (e.g., JP, 2005-257873).

According to an example of JP 2005-257873, the heat sink is disposed near a light source of each red, green, and blue, and each light source is oriented in three specific directions of cross directions about a light synthesizing portion. The cooling air absorbed through the inlet deprives each light source of the heat by cooling each heat sink. Therefore, the cooling air absorbed through the inlet cools the plurality of heat sinks while circulating around the whole periphery of the projection display apparatus, and then is drew out through the outlet disposed at a position away from the inlet.

However, according to the above-described example, the cooling air absorbed through the inlet cools the plurality of heat sinks while circulating the whole periphery of the projection display apparatus. In such a configuration, the flow path needs to be disposed over the projection display apparatus, and thus, the projection display apparatus is increased in size. Thus, a big problem is caused in manufacturing the small housing members.

A cooling unit according to the third embodiment includes the inlet that draws in cooling air from an outside and the outlet that draws out the cooling air to the outside. The airflow path that connects the outlet to the inlet forms a turning-back shape so that the outbound path from the inlet and the inbound pathway to the outlet are disposed adjacent to each other.

According to the third embodiment, the airflow path that connects the outlet to the inlet forms a turning-back shape so that the outbound path from the inlet and the inbound pathway to the outlet are disposed adjacent to each other. Therefore, the area where the airflow path is disposed can be reduced, and a size of the entire cooling unit can be reduced while balancing a cooling capability.

### Third Embodiment

### (Outline of Projection Display Apparatus)

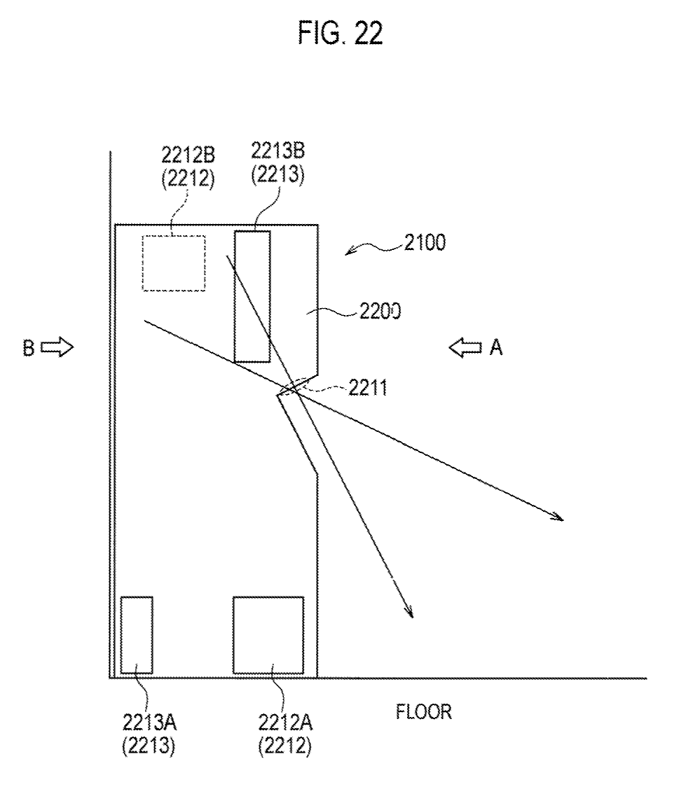

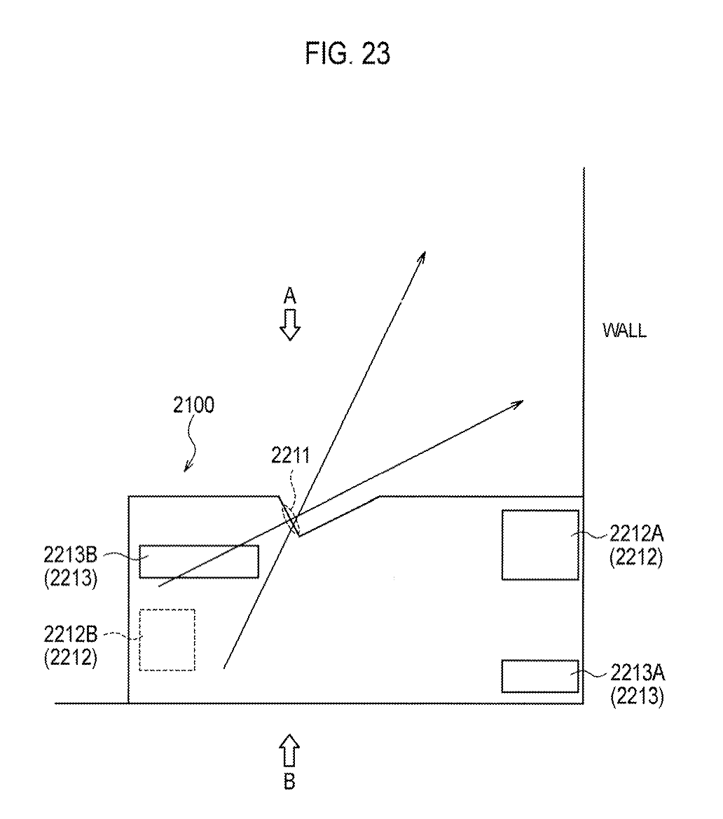

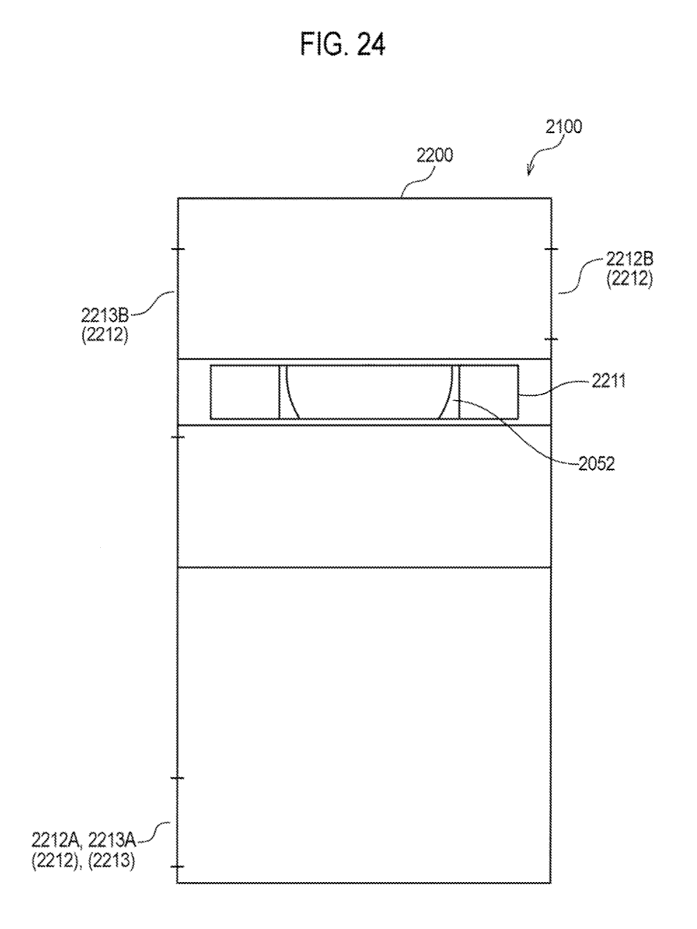

An outline of the projection display apparatus according to the third embodiment will be described with reference to the drawings as follows. FIG. 22 is a side view of the projection display apparatus 2100 (floor face projection) according to the third embodiment. FIG. 23 is a side view of the projection display apparatus 2100 (wall face projection) according to the third embodiment. FIG. 24 is a front view of the projection display apparatus 2100 according to the third embodiment.

Herein, for sake of convenience with a space, with reference to FIG. 22, a face disposed on a top is defined as a top face, a face (installation face) disposed on a bottom is defined as a bottom face, a face disposed at the right side face is defined as a front face, a face disposed at the left side face is defined as a rear face, a face disposed at a near side is defined as a left side face, and a face disposed at a farther side is defined as a right side face.

As shown in FIG. 22 and FIG. 23, the projection display apparatus 2100 includes the housing member 2200, and projects the image onto the projection plane. As shown in FIG. 22, the projection plane may be provided on the floor face or, as shown in FIG. 23, may be provided on the wall face.

A transparent region 2211 through which the image light passes is provided for the housing member 2200. The image light projected from the projection display apparatus 2100 is once collected near the transparent region 2211, and then enlarged and projected onto the projection face (refer to the arrows that pass through the transparent region 2211 shown in FIG. 22 and FIG. 23). The inlets 2212 (inlet 2212A and inlet 2212B) and the outlets 2213 (outlet 2213A and outlet 2213B) are provided for the housing member 2200.

As shown in FIG. 22 to FIG. 24, the inlet 2212A is provided near the bottom face and the front face of the left side face of the housing member 2200. The inlet 2212B is provided near the top face and the rear face of the right side face of the housing member 2200. The outlet 2213A is provided near the bottom face and the rear face of the left side face of the housing member 2200. The outlet 2213B is provided near the bottom face and the front face of the left side face of the housing member 2200.

The outlets 2213 (outlet 2213A and outlet 2213B) are provided on the left side face of the housing member 2200, and provided so that the outlets are oriented in the same direction.

### (Details of Projection Display Apparatus)

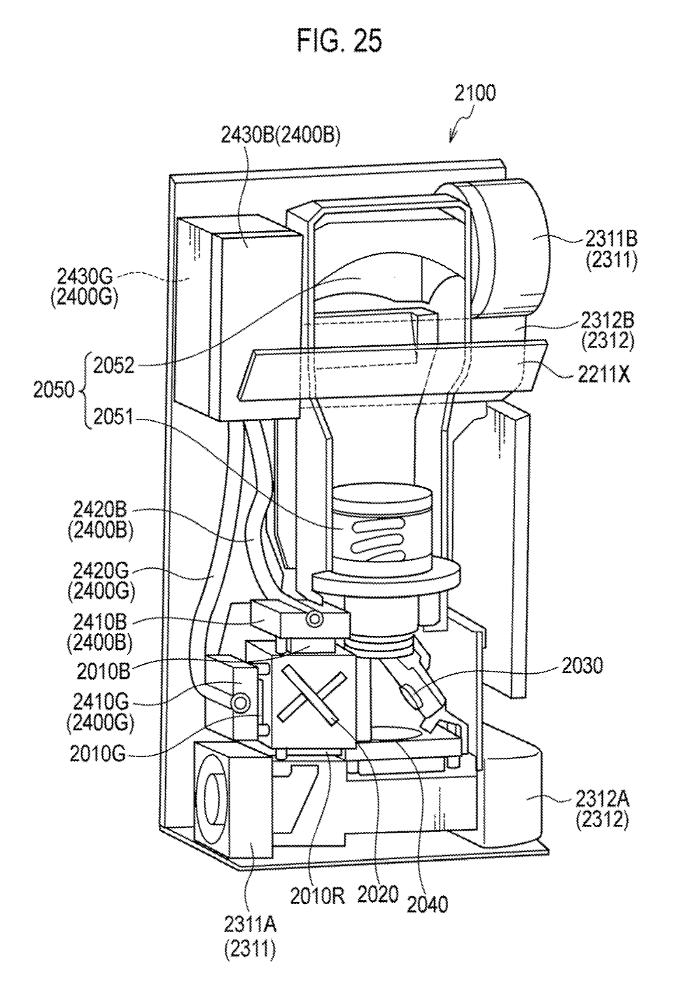

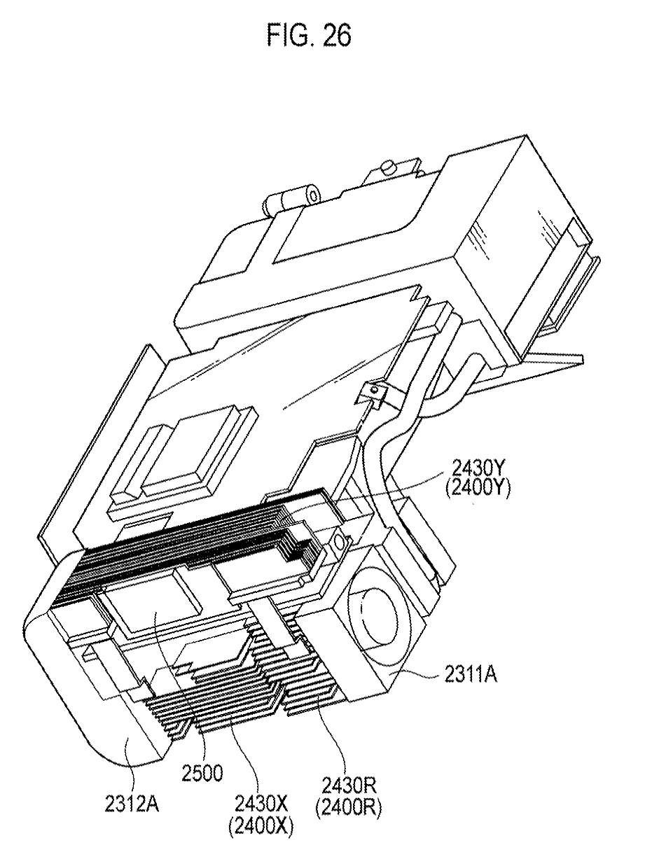

The details of the projection display apparatus according to the third embodiment will be described with reference to the drawings as follows. FIG. 25 and FIG. 26 show the details of the projection display apparatus 2100. FIG. 25 is a perspective view in which the front face of the projection display apparatus 2100 is viewed from the diagonally upward direction thereof. FIG. 26 is a perspective view in which the bottom face of the projection display apparatus 2100 is viewed from the diagonally downward direction thereof. In FIG. 25 and FIG. 26, an internal configuration of the projection display apparatus 2100 is shown.

As shown in FIG. 25 and FIG. 26, the projection display apparatus 2100 includes light sources 2010 (light source 2010R, light source 2010G, and light source 2010B) and a cross dichroic mirror 2020, a turning mirror 2030, a DMD 40, and a projection optical unit 2050.

The light source 2010R emits the red component light R, for example, the red LED and the red LD. The light source 2010G emits the green component light G, for example, the green LED and the green LD. The light source 2010G emits the blue component light B, for example, the blue LED and the blue LD.

The cross dichroic mirror 2020 transmits the green component light G emitted from the light source 2010G, reflects the blue component light B and the red component light R emitted from the light source 2010B and the light source 2010R, and leads the red component light R, the green component light G, and the blue component light B to a turning mirror 2030.

The cross dichroic mirror 2020 transmits the green component light G emitted from light source 2010G, reflects the blue component light B and the red component light R emitted from the light source 2010B and the light source 2010R, and leads the red component light R, the green component light G, and the blue component light B to the turning mirror 2030. The dichroic mirror that reflects the light source 2010R is not provided on one line with the dichroic mirror that reflects the light source 2010B, and thus the cross dichroic mirror 2020 is shifted for being provided. With this arrangement, compared with the dichroic mirrors provided on one line in a cross shape, permeability of the light of the light source 2010G on a joint surface on which the dichroic mirrors are connected with each other is increased.

The turning mirror 2030 reflects the component light R, the green component light G, and the blue component light B emitted from the cross dichroic mirror 2020 to the DMD 2040 side.

The DMD 2040 is formed of the plurality of minute mirrors, which are a movable type. The DMD 2040 switches whether to reflect the light reflected by the turning mirror 2030 to the projection optical unit 2050 by changing an angle of each minute mirror.

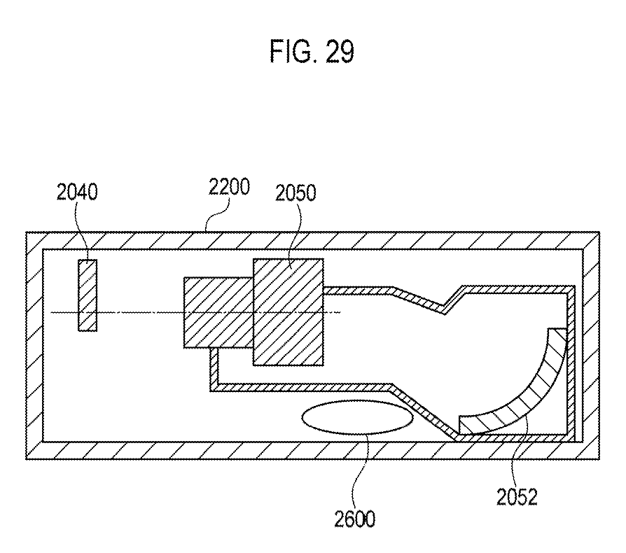

The center of the DMD 2040 is shifted from the optical axis of the projection optical unit 2050 as shown in FIG. 29.

The projection optical unit 2050 projects the image light emitted from the DMD 2040 onto the projection plane. For example, the projection optical unit 2050 includes a projection lens group 2051 and a reflection mirror 2052.

The projection lens group 2051 emits the image light emitted from the DMD 2040 to the reflection mirror 2052 side. The projection lens group 2051 includes the lens in a circular shape about the optical axis of the projection optical unit 2050.

The diameter of the lens included in the projection optical unit 2050 is larger as getting closer to the reflection mirror 2052. Moreover, the diameter of the lens of the reflection mirror 2052 is larger than the diameter of the lens included in the projection optical unit 2050.

The reflection mirror 2052 reflects the image light emitted from the projection lens group 2051 onto the projection plane side. The reflection mirror 2052 is an aspheric mirror that includes a concave surface at the DMD 2040 side, for example.

The projection display apparatus 2100 includes fans 2311 (fan 2311A, fan 2311B) and ducts 2312 (duct 2312A and duct 2312B).

The fan 2311 generates the airflow from the inlet 2212 to the outlet 2213 in the airflow path formed of the duct 2312. More specifically, the fan 2311A leads the air to the outside of the housing member 2200 through the inlet 2212A into the duct 2312A as the cooling air. The fan 2311B leads the air to the outside of the housing member 2200 through the inlet 2212B into the duct 2312B as the cooling air.

The fan 2311A is provided near the bottom face and the front face on the left side face of the housing member 2200, the fan 2311B is provided near the top face and the rear face on the right side face of the housing member 2200 (refer to FIG. 25). Thus, the fan 2311A and the fan 2311B are each provided at the positions of the opposite corners.

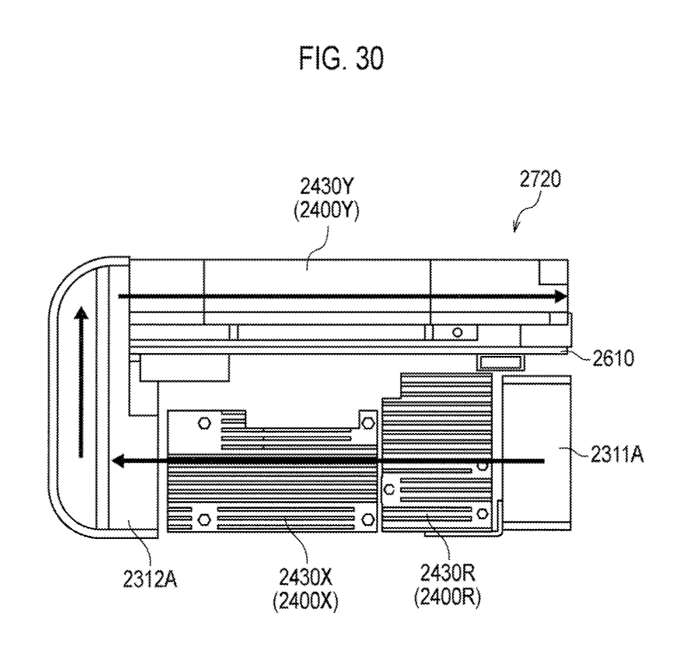

The duct 2312 forms the airflow path from the inlet 2212 to the outlet 2213. More specifically, the duct 2312A forms a part of the airflow path from the inlet 2212A to the outlet 2213A. Moreover, the duct 2312B forms the entire airflow path from the inlet 2212B to the outlet 2213B. The duct 2312A may form a part of the airflow path or the whole part thereof. Further, although the duct 2312A does not form all of the airflow path as a duct, it may perform a function of the duct for covering the entire airflow path by the duct 2312A that forms a part of the airflow, a housing member 2200, and a partition wall 2610 (refer to FIG. 30) described below. Moreover, the duct 2312B may form all of the airflow path or a part thereof.

The projection display apparatus 2100 includes the cooling units 2400 (cooling unit 2400R, cooling unit 2400G, cooling unit 2400B, cooling unit 2400X, and cooling unit 2400Y).

The cooling unit 2400R cools the light source 2010R. According to the third embodiment, the cooling unit 2400R refers to the cooling fins 2430R.

The cooling unit 2400G cools the light source 2010G. The cooling unit 2400G includes the heat receiving portion 2410G, the heat pipe 2420G, and the cooling fins 2430G.

The cooling unit 2400B cools the light source 2010B. The cooling unit 2400B includes the heat receiving portion 2410B, the heat pipe 2420B, and the cooling fins 2430B.

The cooling unit 2400X cools the DMD 2040. According to the third embodiment, the cooling unit 2400X refers to the cooling fins 2430X.
The cooling unit 2400Y cools a driver base plate 20500 (refer to FIG. 26) that drives the light source 2010. According to the third embodiment, the cooling unit 2400Y refers to the cooling fins 2430Y.

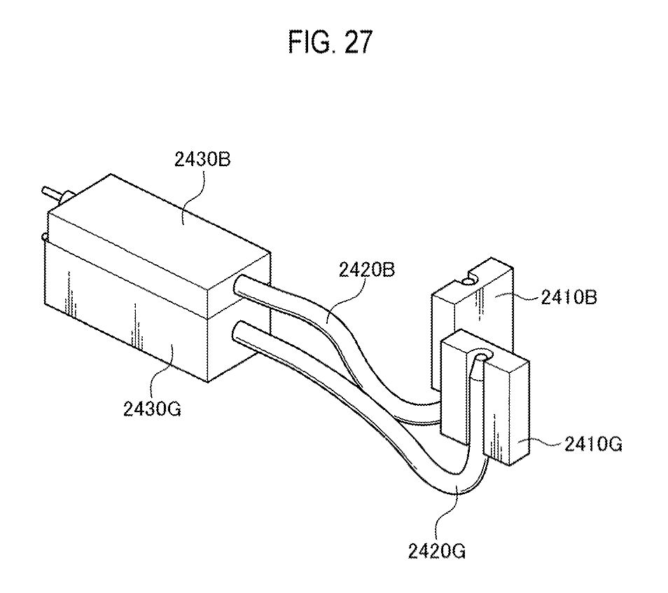

FIG. 27 shows the details of the cooling unit 2400G and the cooling unit 2400B according to the third embodiment.

As shown in FIG. 27, the cooling unit 2400G and the cooling unit 2400B include the heat receiving portion 2410G, the heat receiving portion 2410B, the heat pipe 2420G, the heat pipe 2420B, the cooling fins 2430G, and the cooling fins 2430B.

The heat receiving portion 2410G and the heat receiving portion 2410B receives the heat as the light source 2010B and the light source 2010G being the heat source. The heat pipe 2420G and the heat pipe 2420B transmit the heat to the cooling fins 2430G and the cooling fins 2430B. The cooling fins 2430G and the cooling fins 2430B are disposed on the airflow path of the cooling air.

More specifically, the heat receiving portion 2410G receives the heat of the light source 2010G, and the heat pipe 2420G transmits the heat of the light source 2010G to the cooling fins 2430G. Similarly, the heat receiving portion 2410B receives the heat of the light source 2010B, and the heat pipe 2420B transmits the heat of the light source 2010B to the cooling fins 2430B.

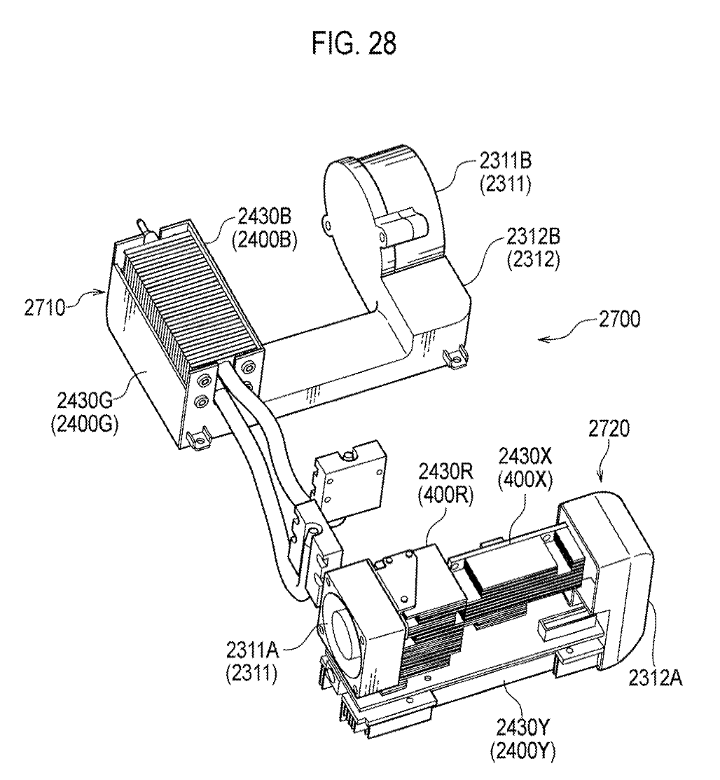

The details of the cooling unit 2400G, the cooling unit 2400B, duct 2312B, and the fan 2311B (herebelow, referred to as the first cooling unit 2710 in the above-described group) will be described below with reference to FIG. 27 to the FIG. 28. The details of the cooling unit 2400R, the cooling unit 2400X, the cooling unit 2400Y, the duct 2312A, and the fan 2311A (herebelow, referred to as the second cooling unit 2720 in the above-described group) will be described below with reference to FIG. 30.

### (Details of First Cooling Unit)

The details of the first third embodiment according to the cooling unit 2710 are described with reference to the drawing as follows.

FIG. 28 shows details of the first cooling unit 2710 including the fan 2311B and the duct 2312B and the second cooling unit 2720 will be described below, in addition to the cooling unit 2400G and the cooling unit 2400B shown by FIG. 27. According to the third embodiment, the cooling apparatus 2700 including the first cooling unit 2710 and the second cooling unit 2720 is defined.

The fan 2311B is a sirocco fan. The fan 2311B leads the cooling air from the inlet 2212B of the housing member 2200 to the inside of the housing member 2200. The duct 2312B is connected to a discharging outlet of the fan 2311B.

The duct 2312B operates as an airflow path that leads the cooling air led from the fan 2311B to the cooling unit 2400G and the cooling unit 2400B. The projection optical unit 2050 is provided between the fan 2311B, and the cooling unit 2400G and the cooling unit 2400B (refer to FIG. 25). The diameter of the lens included in the projection lens group 2051 becomes larger as getting closer to the reflection mirror 2052. The reflection mirror 2052 is provided closer to the rear face side of the housing member 2200 than the projection lens group 2051. Therefore, as shown in FIG. 29, a gap 2600 is generated by a difference between the positions where the reflection mirror 2052 and the projection lens group 2051 are provided. More specifically, the optical axis passing the center of the DMD 2040 is shifted with respect to the optical axis passing the center of the projection lens group 2051 and thus the light emitted from the projection lens group 2051 tilts. With an amount of the tilt, the reflection mirror 2052 is shifted with respect to the optical axis of the projection lens of the reflection mirror 2052. Therefore, the gap 2600 is generated between the projection optical unit 2050 and the housing member 2200. The duct 2312B is formed to run in the gap 2600, and forms the airflow path for leading the cooling air to the cooling fins 2430G and the cooling fins 2430B.

The fan 2311B is disposed near the inlet 2212B to operate as an inlet fan, however not limited thereto. For example, it may be disposed near the outlet 2213B and operate as an outlet fan. As long as it is used as the outlet fan, an axial fan may be used in place of the sirocco fan.

### (Details of Second Cooling Unit)

The details of the second cooling unit 2720 according to the third embodiment will be described with reference to the drawing as follows. FIG. 30 shows the details of the second cooling unit 2720 including the cooling unit 2400R, the cooling unit 2400X, the cooling unit 2400Y, and the duct 2312A according to the third embodiment with reference to the drawings.

The fan 2311A is an axial fan and leads the cooling air through the inlet 2212A of the housing member 2200 into the housing member 2200. The cooling fins 2430R are provided at a blowing outlet of the fan 2311A.

The cooling fins 2430R radiate the heat of the light source 2010R by the cooling air led by the fan 2311A. The cooling air used for radiation is led to the cooling fins 2430X provided at the blowing cutlet of the cooling fins 2430R. The plurality of cooling fins are provided so that the cooling fins 2430R are arranged in parallel with a direction in which the cooling air travels.

The cooling fins 2430X radiate the heat of the DMD 2040 by the cooling air led from the cooling fins 2430R. The cooling air used to radiate the heat is led to the duct 2312A provided in at the blowing outlet of the cooling fins 2430X. The plurality of cooling fins are provided so that the cooling fins 2430X are arranged in parallel with a direction in which the cooling air travels. The airflow path where the cooling fins 2430R and the cooling fins 2430X are provided is referred to as an outbound path.

The duct 2312A bends the traveling direction of the cooling air led from the cooling fins 2430X in a U-like shape, and reverses the traveling direction at an angle of 180 degrees. The duct 2312A leads the cooling air to the cooling fins 2430Y provided at the blowing outlet of the duct 2312A. Corners of a blowing inlet and the blowing outlet of the duct, 2312A have a curved surface, which facilitates changing the traveling direction of the cooling air.

The cooling fins 2430Y radiates the heat of the driver base plate 20500 by the cooling air led from the duct 2312A, and draws out the cooling air to the outside of the housing member 2200 from the outlet 2213A of the housing member 2200 provided at the blowing outlet of the cooling fins 2430Y. The plurality of cooling fins are provided so that the cooling fins 2430Y are arranged in parallel with the traveling direction of the cooling air. The airflow path where the cooling fins 2430Y are provided is referred to as an inbound path.

The partition wall 2610 for preventing the cooling air from leaking between the cooling fins 2430R, 2430X and the cooling fins 2430Y is provided. The partition wall 2610 prevents the cooling air from entering directly from the cooling fins 2430R and 2430X into the cooling fins 2430Y.

The fan 2311A is disposed near the inlet 2212A, and operates as the inlet fan, however not limited thereto. For example, the fan 2311A may be disposed near the outlet 2213A, and may operate as an outlet fan.

According to the third embodiment, the cooling unit in a turn shape shown in FIG. 30 is described as an example, however, it is not limited thereto. Two cooling units in a turning shape according to the third embodiment may be connected to each other to make the cooling unit in an S-like shape. Moreover, two or more cooling units in a turning shape may be connected to one another.

### (Operation and Effect)

According to the third embodiment, the airflow path that connects the outlet 2213A to the inlet 2212A forms a turning shape, and the outbound path from the inlet 2212A and the inbound path to the outlet 2213A are disposed adjacent to each other. Therefore, the installation area necessary for the airflow path can be reduced, and also the size of the entire cooling unit can be reduced while balancing a cooling capability.

According to the third embodiment, at least one cooling fin is disposed in the outbound path and the inbound path respectively. Thus, the outbound path and the inbound path are effectively used to densely dispose the cooling fins on the airflow path, thereby enabling to reduce the size of the cooling unit.

According to the third embodiment, the airflow path from the inlet 2212A or the inlet 2212B to the outlet 2213A or the outlet 2213B and the cooling fins may be covered with the duct 2312A (duct 2312A, inner wall of housing member 2200, including the duct function by partition wall 2610) or the duct 2312B. Therefore, since the cooling air that flows in the airflow path cannot leak from the duct 2312A or 2312B, the cooling efficiency of the cooling unit can be improved.

According to the third embodiment, the outlet 2213B of the first cooling unit 2710 and the outlet 2213 of the second cooling unit 2720 have the same outlet direction. Therefore, when discharging the cooling air warmed by the projection display apparatus, the warmed cooling air can be easily avoid from being drew out toward a user.

According to the third embodiment, the fan 2311A and the fan 2311B are each provided at the positions of the opposite corners. Therefore, since generated fan-operation sound is not concentrated in a specific direction, uncomfortable feelings of the user caused by excessive operation sound can be reduced.

### Outline of Fourth Embodiment

Conventional projection optical units that include the projection optical unit for projecting the light emitted from the illumination optical unit onto the projection plane has been known. The illumination optical unit includes the light source such as the LED and the imager that modulates the light emitted from the light source. The projection optical unit includes the projection lens for projecting the modulated light emitted from the illumination optical unit onto a screen. Moreover, the projection display apparatus includes the cooling unit such as the heat sink that cools the heat source of the light source (e.g., JP 2005-257873).

According to the example of JP, 2005-257873, the heat sink is disposed near each light source of red, green, and blue. Each light source is disposed in specific three directions in a cross direction about a light synthesizing unit. The cooling air inlet through the inlet deprives the heat source such as each light source of the heat by cooling each heat sink. Therefore, the cooling air inlet through the inlet cools the plurality of heat sinks while circulating, the whole periphery in the projection display apparatus, and then is drew out through the outlet disposed away from the inlet.

However, according to the above-described example, the cooling air inlet through the inlet cools the plurality of heat sinks while circulating, the whole periphery in the projection display apparatus. In such a configuration, the duct of the cooling air should be disposed over the whole periphery in the projection display apparatus.

Therefore, due to the area of the flow path of the cooling air, the installation area of the projection display apparatus needs to be increased, thereby increasing the size of the projection display apparatus. Thus, a big problem is caused in manufacturing the small housing members.

A projection display apparatus according to a fourth embodiment includes the housing member, the light source that emits the light, the imager that modulates the light from the light source based on an image input signal, a projection optical unit that enlarges and projects the modulated light from the imager onto the projection plane, and the cooling unit that cools the heat source. The projection optical unit includes the projection lens that enlarges and projects the modulated light from the imager and a reflection mirror that reflects the enlarged projection light from the projection lens onto the projection plane. A gap is formed between the projection optical unit and the housing member by an optical axis passing a center of the imager being shifted with respect to an optical axis passing a center of the projection lens. The duct forming an airflow path of the cooling unit is provided in the gap.

According to the fourth embodiment, the optical axis passing the center of the imager is shifted with respect to the optical axis passing the center of the projection lens and thus the light emitted from the projection lens tilts. With an amount of the tilt, the reflection mirror is shifted with respect to the optical axis of the projection lens. Therefore, the gap is generated between the projection optical unit and the housing member, and thus the duct forming the airflow path of the cooling unit can be provided. Accordingly, by effectively using the dead space, the small projection display apparatus can be used.

### Fourth Embodiment

### (Outline of Projection Display Apparatus)

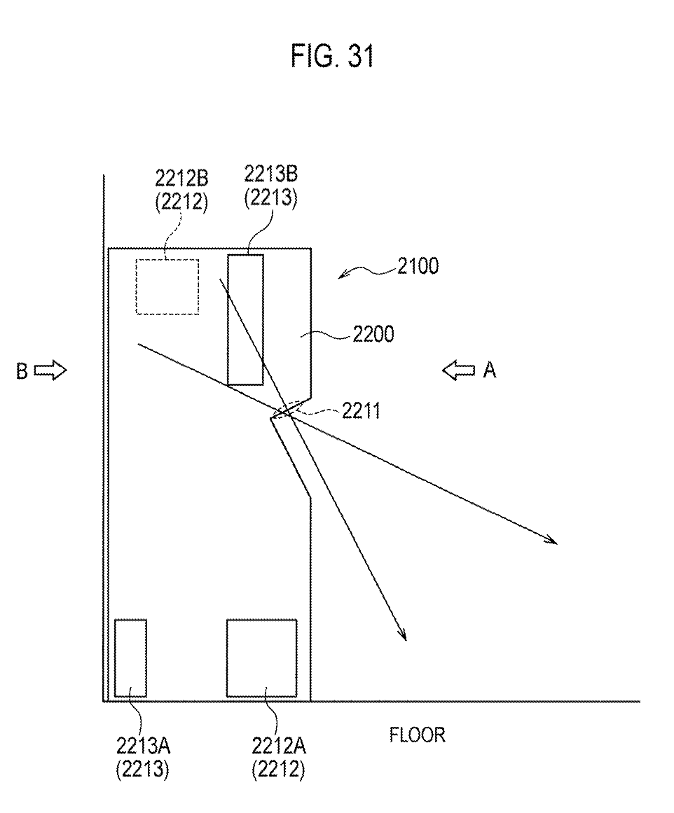

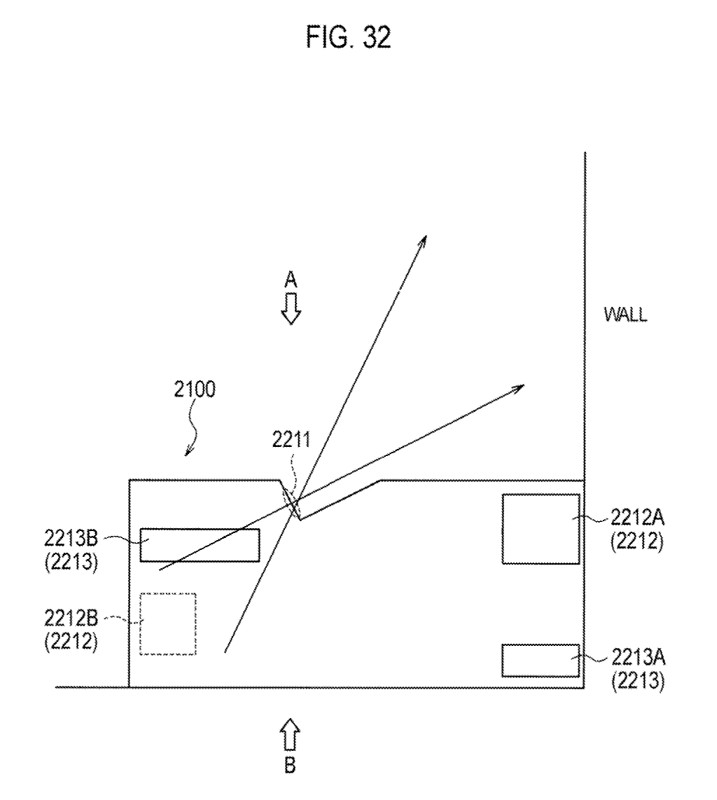

The outline of the projection display apparatus according to the fourth embodiment will be described with reference to the drawing as follows. FIG. 31 is a side view of the projection display apparatus 2100 (floor face projection) according to the fourth embodiment. FIG. 32 is a side view of the projection display apparatus 2100 (wall face projection) according to the fourth embodiment.

Herein, for sake of convenience with a space, with reference to FIG. 31, a face disposed on a top is defined as a top face, a face (installation face) disposed on a bottom is defined as a bottom face, a face disposed at the right side face is defined as a front face, a face disposed at the left side face is defined as a rear face, a face disposed at a near side is defined as a left side face, and a face disposed at a farther side is defined as a right side face.

As shown in FIG. 31 and FIG. 32, the projection display apparatus 2100 includes the housing member 2200, and projects the image onto the projection plane. As shown in FIG. 31, the projection plane may be provided on the floor face or, as shown in FIG. 32, may be provided on the wall face.

A transparent region 2211 through which the image light passes is provided for the housing member 2200. The image light projected from the projection display apparatus 2100 is once collected near the transparent region 2211, and then enlarged and projected onto the projection face (refer to the arrows that pass through the transparent region 2211 shown in FIG. 31 and FIG. 32). The inlets 2212 (inlet 2212A and inlet 2212B) and the outlets 2213 (outlet 2213A and outlet 2213B) are provided for the housing member 2200.

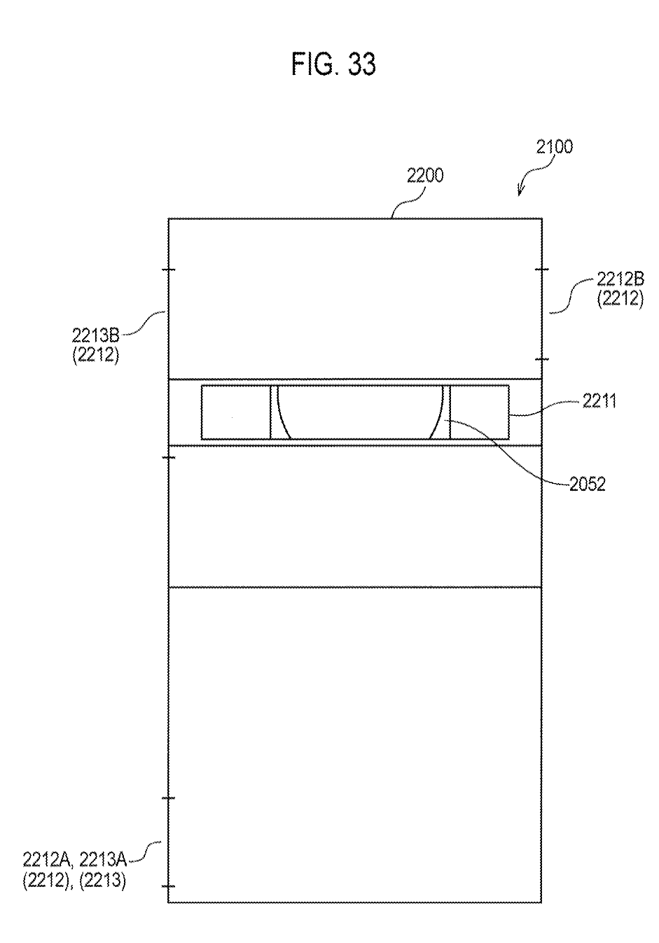

As shown in FIG. 31 to FIG. 33, the inlet 2212A is provided near the bottom face and the front face of the left side face of the housing member 2200. The inlet 2212B is provided near the top face and the rear face of the right side face of the housing member 2200. The outlet 2213A is provided near the bottom face and the rear face of the left side face of the housing member 2200. The outlet 2213B is provided near the bottom face and the front face of the left side face of the housing member 2200.

The outlets 2213 (outlet 2213A and outlet 2213B) are provided on the left side face of the housing member 2200, and provided so that the outlets are oriented in the same direction.

### (Details of Projection Display Apparatus)

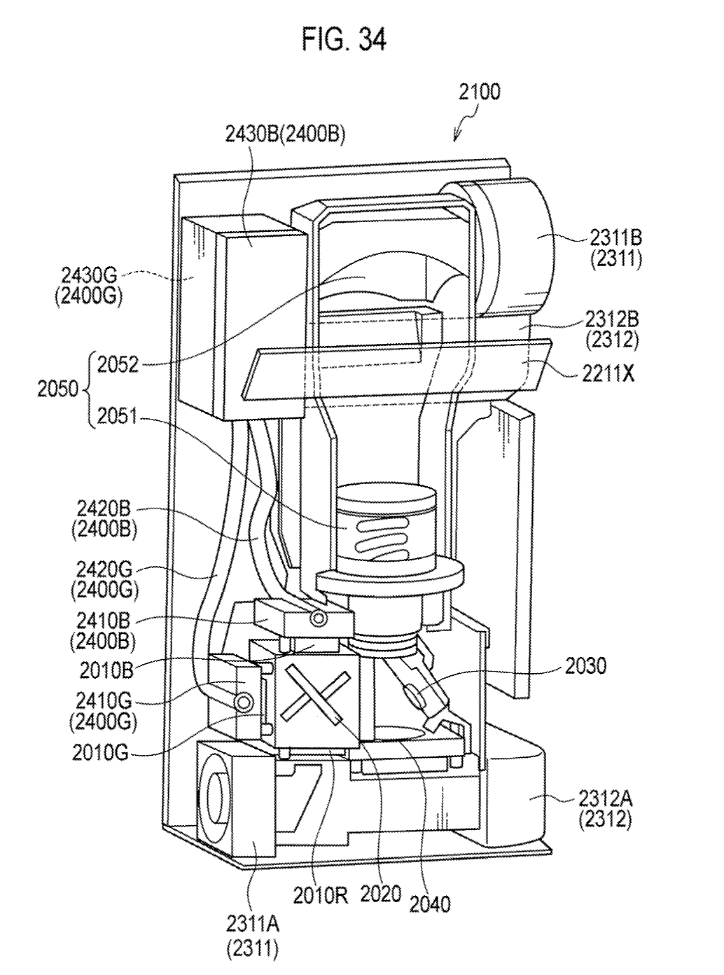

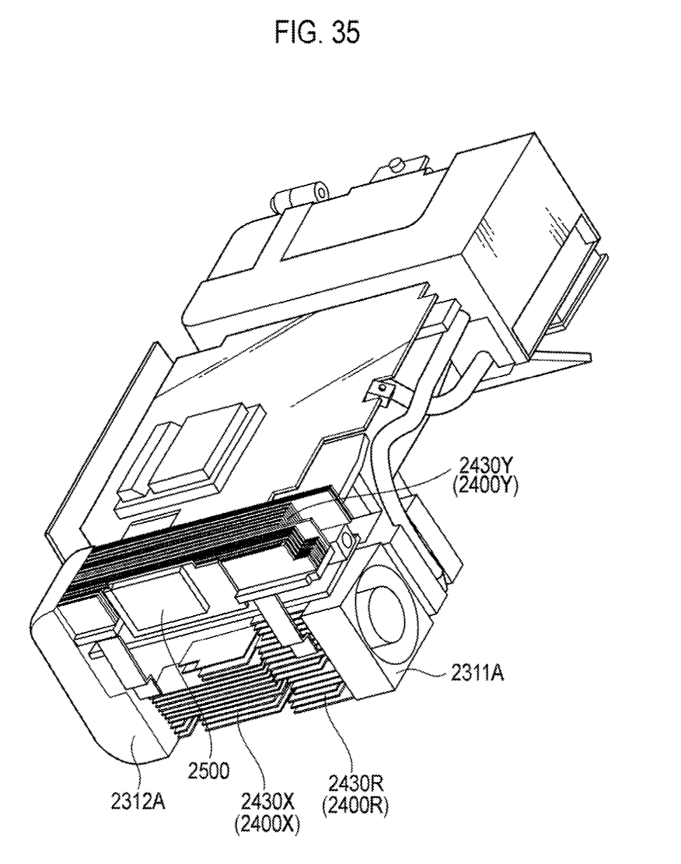

The details of the projection display apparatus according to the fourth embodiment will be described with reference to the drawing as follows. FIG. 34 and FIG. 35 show the details of the projection display apparatus 2100. FIG. 34 is a perspective view in which the front face of the projection display apparatus 2100 is viewed from the diagonally upward direction thereof. FIG. 34 is a perspective view in which the bottom face of the projection display apparatus 2100 is viewed from the diagonally downward direction thereof. In FIG. 34 and FIG. 35, an internal configuration of the projection display apparatus 2100 is shown.

As shown in FIG. 34 and FIG. 35, the projection display apparatus 2100 includes light sources 2010 (light source 2010R, light source 2010G, and light source 2010B) and a cross dichroic mirror 2020, a turning mirror 2030, a DMD 40, and a projection optical unit 2050.

The light source 2010R emits the red component light R, for example, the red LED and the red LD. The light source 2010G emits the green component light G, for example, the green LED and the green LD. The light source 2010B emits the blue component light B, for example, the blue LED and the blue LD.

The cross dichroic mirror 2020 transmits the green component light G emitted from the light source 2010G, reflects the blue component light B and the red component light R emitted from the light source 2010B and the light source 2010R, and leads the red component light R, the green component light G, and the blue component light B to a turning mirror 2030. The dichroic mirror that reflects the light source 2010R is not provided on one line with the dichroic mirror that reflects the light source 2010B, and thus the cross dichroic mirror 2020 is shifted and provided With this arrangement, compared with the dichroic mirrors provided on one line in a cross shape, permeability of the light of the light source 2010G on a joint surface on which the dichroic mirrors are connected with each other is increased.

The turning mirror 2030 reflects the component light R, the green component light G, and the blue component light B emitted from the cross dichroic mirror 2020 to the DMD 2040 side.

The DMD 2040 is formed of the plurality of minute mirrors, which are a movable type. The DMD 2040 switches whether to reflect the light reflected by the turning mirror 2030 to the projection optical unit 2050 by changing an angle of each minute mirror.

The center of the DMD 2040 is shifted from the optical axis of the projection optical unit 2050. For example, the projection optical unit 2050 includes a projection lens group 2051 and a reflection mirror 2052.

The projection optical unit 2050 projects the image light emitted from the DMD 2040 onto the projection plane. For example, the projection optical unit 2050 includes the projection lens group 2051 and the reflection mirror 2052.

The projection lens group 2051 emits the image light emitted from the DMD 2040 to the reflection mirror 2052 side. The projection lens group 2051 includes the lens in a circular shape about the optical axis of the projection optical unit 2050.

The diameter of the lens included in the projection optical unit 2050 becomes larger as getting closer to the reflection mirror 2052. Moreover, the diameter of the lens of the reflection mirror 2052 is larger than the diameter of the lens included in the projection optical unit 2050.

The reflection mirror 2052 reflects the image light emitted from the projection lens group 2051 onto the projection plane side. The reflection mirror 2052 is an aspheric mirror that includes a concave surface at the DMD 2040 side, for example.

The projection display apparatus 2100 includes fans 2311 (fan 2311A, fan 2311B) and ducts 2312 (duct 2312A and duct 2312B).

The fan 2311 generates the airflow from the inlet 2212 to the outlet 2213 in the airflow path formed of the duct 2312. More specifically, the fan 2311A leads the air to the outside of the housing member 2200 through the inlet 2212A into the duct 2312A as the cooling air. The fan 2311B leads the air to the outside of the housing member 2200 through the inlet 2212B into the duct 2312B as the cooling air. The fan 2311A is provided near the bottom face and the front face on the left side face of the housing member 2200, the fan 2311B is provided near the top face and the rear face on the right side face of the housing member 2200 (refer to FIG. 34). Therefore, the fan 2311A and the fan 2311B are each provided at the positions of the opposite corners.

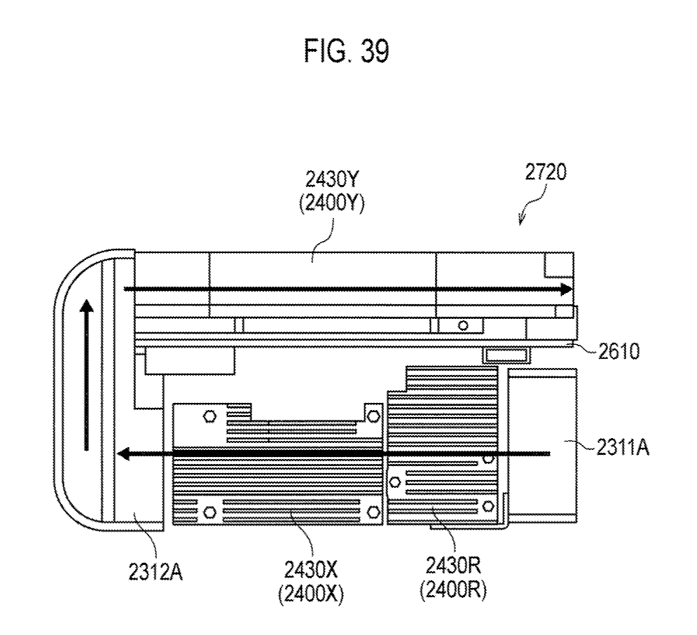

The duct 2312 forms the airflow path from the inlet 2212 to the outlet 2213. More specifically, the duct 2312A forms a part of the airflow path from the inlet 2212A to the outlet 2213A. Moreover, the duct 2312B forms the whole part of the airflow path from the inlet 2212B to the outlet 2213B. The duct 2312A may form a part of the airflow path or the whole part thereof. Further, the duct 2312A may perform a duct function for covering the whole part of the airflow path by the duct 2312A forming a part of the airflow path as a duct, if not forming the whole part, the inner wall of the housing member 2200 and the partition wall 2610 (refer to FIG. 39) will be described below. Moreover, the duct 2312B may form a part of the airflow path or the whole part thereof.

The projection display apparatus 2100 includes the cooling units 2400 (cooling unit 2400R, cooling unit 2400G, cooling unit 2400B, cooling unit 2400X, and cooling unit 2400Y).

The cooling unit 2400R cools the light source 2010R. According to the fourth embodiment, the cooling unit 2400R reference to the cooling fins 2430R.

The cooling units 2400G cool the light source 2010G. The cooling unit 2400G includes the heat receiving portion 2410G, the heat pipe 2420G, and the cooling fins 2430G.

The cooling unit 2400B cools the light source 2010B. The cooling unit 2400B includes the heat receiving portion 2410B, the heat pipe 2420B, and the cooling fins 2430B.

The cooling unit 2400X cools the DMD 2040. According to the fourth embodiment, the cooling unit 2400X refers to the cooling fins 2430X.

The cooling unit 2400Y cools the driver base plate 20500 (refer to FIG. 35) that drives light source 2010. According to the fourth embodiment, the cooling unit 2400Y refers to the cooling fins 2433Y.

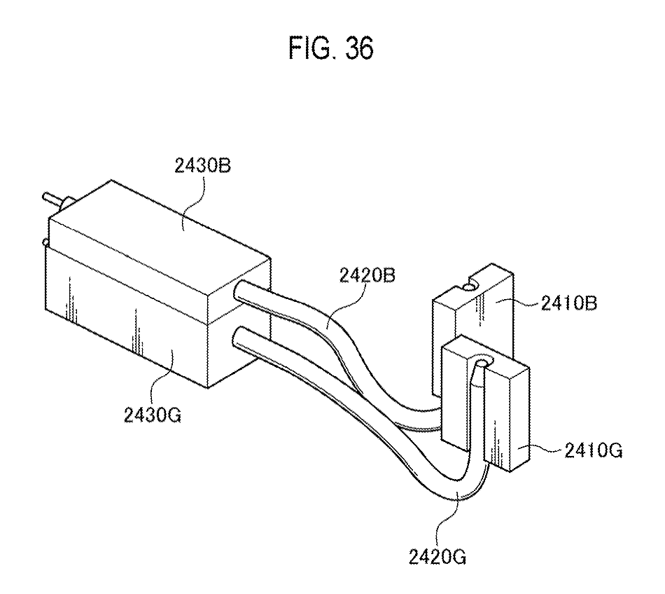

FIG. 36 shows the details of the cooling unit 2400G and cooling unit 2400B according to the fourth embodiment.

The cooling unit 2400G and cooling unit 2400B have the heat receiving portion 2410G, the heat receiving portion 2410B, the heat pipe 2420G, the heat pipe 2420B, the cooling fins 2430G, and the cooling fins 2430B as shown in FIG. 36.

The heat receiving portion 2410G and the heat receiving portion 2410B receive the heat as the light source 2010B and the light source 2010G being the heat source. The heat pipe 2420G and the heat pipe 2420B transmit the heat to the cooling fins 2430G and the cooling fins 2430B. The cooling fins 2430G and the cooling fins 2430B are disposed on the airflow path of the cooling air.

More specifically, the heat receiving portion 2410G receives the heat of the light source 2010G, and the heat pipe 2420G transmits the heat of the light source 2010G to the cooling fins 2430G. Similarly, the heat receiving portion 2410B receives the heat of the light source 2010B, and the heat pipe 2420B transmits the heat of the light source 2010B to the cooling fins 2430B. The cooling fins 2430G and the cooling fins 2430B have been provided at the position adjacent to the projection optical unit 2050 (refer to FIG. 34).

Moreover, the calorific amounts of the light source 2010B and the light source 2010G are larger than the calorific amount of any of the light source 2010R, the DMD 2040 and the driver base plate 20500.

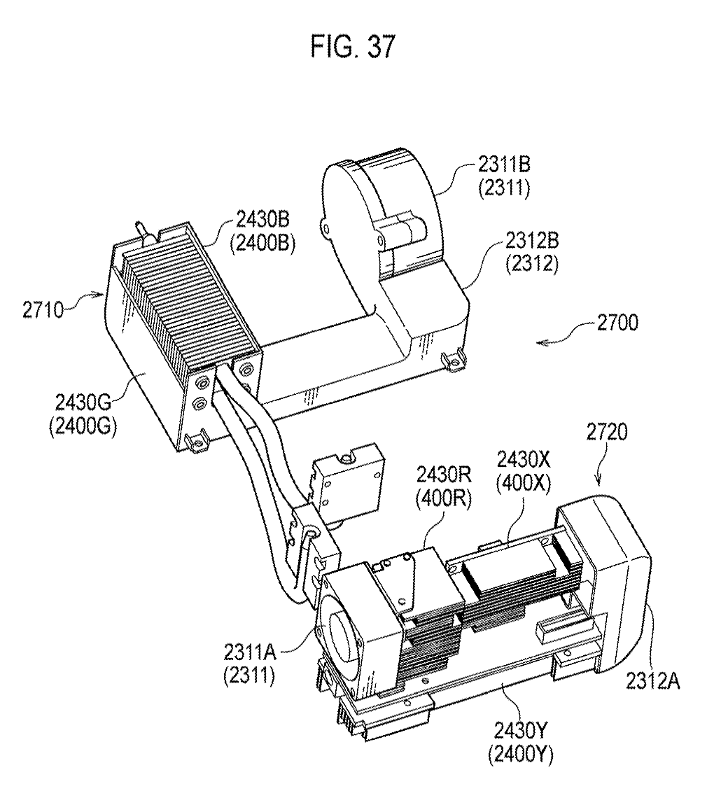

The details of the cooling unit 2400G, the cooling unit 2400B, the duct 2312B, and the fan 2311B (herebelow, referred to as the first cooling unit 2710 in the above-described group) will be described below in FIG. 36 to the FIG. 37. The details of the cooling unit 2400R, the cooling unit 2400X, the cooling unit 2400Y, the duct 2312A, and the fan 2311A (herebelow, referred to as the first cooling unit 2720 in the above-described group) will be described below in FIG. 39.

### (Details of First Cooling Unit)

The details of the cooling unit 2710 according to the first fourth embodiment will be described with reference to the drawing as follows.

In addition to the cooling unit 2400G and the cooling unit 2400B shown in FIG. 36, FIG. 37 shows the details of the first cooling unit 2710 including the fan 2311B and the duct 2312B, and the second cooling unit 2720 described below. According to the fourth embodiment, the first cooling unit 2710 and the second cooling unit 2720 are collectively referred to as the cooling apparatus 2700.

Fan 2311B is a sirocco fan, and it is provided at a position (in a direction opposing to the cooling fins 2430G and the cooling fins 2430B) adjacent to the projection optical unit 2050 (refer to FIG. 34). Fan 2311B leads the cooling air from the inlet 2212B of the housing member 2200 into the housing member 2200. The duct 2312B is connected to the outlet of the fan 2311B.

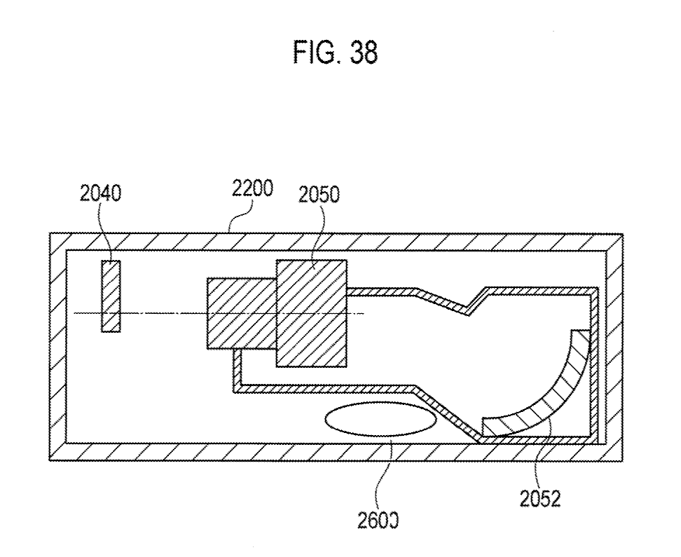

The duct 2312B is an airflow path that leads the cooling air led from the fan 2311B to the cooling unit 2400G and the cooling unit 2400B. The projection optical unit 2050 is provided between the fan 2311B, and the cooling unit 2400G and the cooling unit 2400B (refer to FIG. 34). The diameter of the lens included in the projection lens group 2051 becomes larger as getting closer to the reflection mirror 2052. The reflection mirror 2052 is provided closer to the rear face side of the housing member 2200 than the projection lens group 2051. Therefore, as shown in FIG. 38, the gap 2600 is generated by the difference of the position in which the reflection mirror 2052 and the projection lens group 2051 are provided. More specifically, the optical axis passing the center of the DMD 2040 is shifted with respect to the optical axis passing the center of the projection lens group 2051, and thus the light emitted from the projection lens group 2051 tilts. With an amount of the tilt, the reflection mirror 2052 is shifted with respect to the optical axis of the projection lens. Therefore, the gap 2600 is generated between the projection optical unit 2050 and the housing member 2200. The duct 2312B is formed to run in the gap 2600, and forms the airflow path for leading the cooling air to the cooling fins 2430G and the cooling fins 2430B.

The fan 2311B is disposed near the inlet 2212B to operate as an inlet fan, however not limited thereto For example, it may be disposed near the outlet 2213B and operate as an outlet fan. As long as it is used as the outlet fan, an axial fan may be used in place of the sirocco fan.

### (Details of Second Cooling Unit)

The details of the second cooling unit 2720 according to the fourth embodiment will be described with reference to the drawing as follows. FIG. 39 shows the details of the second cooling unit 2720 including the cooling unit 2400R, the cooling unit 2400X, the cooling unit 2400Y, and the duct 2312A according to the fourth embodiment.

The fan 2311A is an axial fan. The fan 2311 leads the cooling air from the inlet 2212A of the housing member 2200 into the housing member 2200. The cooling fins 2430R are provided at the blowing outlet of the fan 2311A.

The cooling fins 2430R radiate the heat of the light source 2010R by the led cooling air from the fan 2311A. The cooling air used to radiate the heat is led to the cooling fins 2430X provided at the blowing outlet of the cooling fins 2430R. The plurality of cooling fins are provided so that the cooling fins 2430R are arranged in parallel with the traveling direction of the cooling air.

The cooling fins 2430X radiate the heat of the DMD 2040 by the cooling air led from the cooling fins 2430R. The cooling air used to radiate the heat is led to the duct 2312A provided at the blowing outlet of the cooling fins 2430X. The plurality of cooling fins are provided so that the cooling fins 2430X are arranged in parallel with the traveling direction of the cooling air. The airflow path where the cooling fins 2430R and the cooling fins 2430X are provided is referred to as an outbound path.

The duct 2312A bends the traveling direction of the cooling air led from the cooling fins 2430X in a U-like shape, and reverses the traveling direction at the angle of 180 degrees. The duct 2312A leads the cooling air to the cooling fins 2430Y provided at the blowing outlet of the duct 2312A. The corners of the blowing inlet and the blowing outlet of the duct 2312A have the curved surface, which facilitates changing the traveling direction of the cooling air.

The cooling fins 2430Y radiates the heat of the driver base plate 20500 by the cooling air led from the duct 2312A, and draws out the cooling air to the outside of the housing member 2200 from the outlet 2213A of the housing member 2200 provided at the blowing outlet of the cooling fins 2430Y. The plurality of cooling fins are provided so that the cooling fins 2430Y are arranged in parallel with the traveling direction of the cooling air. The airflow path where the cooling fins 2430Y are provided is referred to as the inbound path.

The partition wall 2610 for preventing the cooling air from leaking between the cooling fins 2430R, 2430× and the cooling fins 2430Y is provided. The partition wall 2610 prevents the cooling air from entering directly from the cooling fins 2430R and 2430X into the cooling fins 2430Y.

The fan 2311A is disposed near the inlet 2212A, and operates as the inlet fan, however not limited thereto. For example, the fan 2311A may be disposed near the outlet 2213A, and may operate as an outlet fan.

### (Operation and Effect)

According to the fourth embodiment, the optical axis passing the center of the DMD 2040 is shifted with respect to the optical axis passing the center of the projection lens group 2051, and thus the light emitted from the projection lens group 2051 tilts. With the amount of the tilt, the reflection mirror 2052 is shifted with respect to the optical axis of the projection lens group 205. Therefore, the gap 2600 is generated between the projection optical unit 2050 and the housing member 2200, and the duct 2312B forming the airflow path of the first cooling unit 2710 can be provided. Accordingly, by effectively using the dead space, the small projection display apparatus can be realized.

According to the fourth embodiment, the fan 2311B, the cooling fins 2430B, and 2430G are provided to be adjacent to each other in the direction of opposing the projection optical unit 2050 respectively. Therefore, the projection optical unit 2050 can be disposed at the center of the housing member 2200. With such a configuration, the center of the projection image and the center of the housing member can correspond to each other, and thus, in installing the projection display apparatus 2100, the position of the projection image can be specified without actually projecting the image.

According to the fourth embodiment, the inlet 2212B through which the fan 2311B draw in the cooling air and the outlet 2213B through which the cooling fins 2430B, 2430G discharge the cooling air are provided on different faces of the housing member 2200. Therefore, since the cooling air drew out from the outlet 2213B does not draw in from the inlet 2212B, the cooling efficiency can be improved.

According to the fourth embodiment, at least one second cooling unit 2720 different from the first cooling unit 2710 is included. One of the cooling unit and the another cooling unit cools a high temperature heat source, and the other of the cooling unit and the another cooling unit cools a low temperature heat source having a temperature lower than that of the high temperature heat source. Therefore, since the heat in the high temperature heat source does not impact the low temperature heat source, the cooling efficiency can be improved.

### Other Embodiment

The present invention has been described by means of the embodiment described above, however, the descriptions and the drawings constituting a part of the discloser is not to be understood to limit the invention. From this discloser, those skilled in the art would obviously realize alternative embodiments, embodiments, and operation techniques.

In the embodiment, the DMD is merely illustrated as an imager. The imager may be a liquid crystal panel of a reflection type or a transmission type.

In the embodiment, a case has been described in which the illumination optical unit 310 and the cooling apparatus 330 are disposed in the space provided at the side of the projection optical unit 320 of the dead space (second layout space 420) generated by the arrangement of the projection optical unit 320. However, the embodiment is not limited thereto. More specifically, the illumination optical unit 310 and the cooling apparatus 330 may be disposed in the space provided at the lower side of the projection optical unit 320 of the dead space (second layout space 420) generated by the arrangement of the projection optical unit 320. Alternately, the illumination optical unit 310 and the cooling apparatus 330 are disposed in the space provided at the upper side of the projection optical unit 320 of the dead space (second layout space 420) generated by the arrangement of the projection optical unit 320.

What is claimed is:

1. A projection display apparatus comprising: a housing member that accommodates an illumination optical unit; a projection optical unit; and a cooling unit, wherein
the housing member includes a layout space in a virtually columnar shape having a bottom that is a circumscribed circle of the projection optical unit in a cross sectional view vertical to the projection optical unit;
the layout space includes a first layout space in a substantially conical shape and a second layout space excluding the first layout space;
the projection optical unit is provided in the first layout space; and
at least a part of the illumination optical unit and the cooling unit is provided in the second layout space; and
the illumination optical unit and the cooling unit are disposed in a symmetrical positional relationship with respect to the projection optical unit.

2. The projection display apparatus according to claim 1, wherein the cooling unit is connected to the illumination optical unit by a heat pipe.

3. The projection display apparatus according to claim 1, wherein
the illumination optical unit includes a light source and an imager that modulates light emitted from the light source;
the housing member accommodates a duct that forms an airflow path for leading the heat generated by the imager to an outside of the housing member; and
the duct forms an airflow path for leading the heat absorbed by the cooling unit to the outside of the housing member.

4. The projection display apparatus according to claim 1, further comprising, a fan that forms an airflow from au upper side to a lower side, in an airflow path formed by a duct.

5. A projection display apparatus comprising a housing member that accommodates an illumination optical unit, a projection optical unit, and a cooling unit, wherein,
in a front view of the housing member, the illumination optical unit and the cooling unit are disposed in a symmetrical positional relationship with respect to the projection optical unit, and
in a side view of the housing member, the illumination optical unit and the cooling unit are disposed to overlap the projection optical unit.

6. A cooling unit including a plurality of cooling fins connected to a heat pipe and disposed at a predetermined interval along a direction in which the heat pipe extends, the cooling unit comprising:
a fin body in a plate shape that includes a main surface vertical to the direction in which the heat pipe extends; and
an airflow guiding wall that includes an airflow guiding surface vertical to the main surfaces, wherein
the airflow guiding wall is provided to lead cooling air supplied to the plurality of cooling fins into difference directions.

7. The cooling unit according to claim 6, wherein the main surface has a rectangular shape, and the airflow guiding wall is provided along two sides adjacent to each other on the mains surface.

8. The cooling unit according to claim 6, further comprising:
a first cooling fins provided in a first individual unit connected to a first heat pipe, as the cooling fins; and
a second cooling fins provided in a second individual unit connected to a second heat pipe, as the cooling fins, wherein
the first individual unit and the second individual unit are disposed adjacent to each other at an interval on the airflow path formed of the cooling fins.

9. The cooling unit according to claim 8, wherein
the first individual unit cools a first heat source;
the second individual unit cools a second heat source having calorific amount smaller than calorific amount of the first the heat source; and
the first individual unit and the second individual unit are disposed so that the cooling air is led from the first individual unit to the second individual unit.

10. A projection display apparatus comprises the cooling unit according to any one of claims 6 to 9.

11. A cooling unit comprising:
an inlet that draws in cooling air from an outside; and
an outlet that draws out the cooling air to the outside,
wherein an airflow path that connects the inlet to the outlet forms a turning shape, and an outbound path from the inlet and an inbound path to the outlet are adjacent to each other.

12. The cooling unit according to claim 11, wherein at least one cooling member is disposed in each of the outbound path and the inbound path.

13. The cooling unit according to claim 12, wherein the airflow path from the inlet to the outlet and the cooling member are covered with a duct.

14. A cooling apparatus comprising a cooling unit according to claim 11 and another cooling unit different from the cooling unit,
the outlets of the cooling unit and the outlet of the another cooling unit are oriented in the same direction.

15. The cooling apparatus according to claim 14, further comprising:
a cooling fan disposed in the cooling unit and that draws in or draws out the cooling air; and
an another cooling fan disposed in the another cooling unit and that draws in or draws out the cooling air, wherein
the cooling fan and the another cooling fan are each provided at positions of opposite corners.

16. A projection display apparatus comprising the cooling unit according to any one of claims 11 to 13.

17. A projection display apparatus comprising the cooling apparatus according to either one of claims 14 to 15.

18. A projection display apparatus comprising:
a housing member;
a light source that emits the light;
an imager that modulates the light from the light source based on an image input signal;
a projection optical unit that enlarges and projects the modulated light from the imager onto a projection plane; and
a cooling unit that cools a heat source, wherein
the projection optical unit includes a projection lens that enlarges and projects the modulated light from the imager and a reflection mirror that reflects the enlarged projection light from the projection lens onto the projection plane;
a gap is formed between the projection optical unit and the housing member by an optical axis passing a center of the imager being shifted with respect to an optical axis passing a center of the projection lens; and
a duct forming an airflow path of the cooling unit is provided in the gap.

19. The projection display apparatus according to claim 18, wherein
the cooling unit includes a draw-in unit that draws in cooling air and a cooling unit that cools heat using the cooling air,
the draw-in unit and the cooling unit are provided adjacent to each other in an opposing direction of the projection optical unit.

20. The projection display apparatus according to claim 19, wherein
an inlet where the draw-in unit draws in the cooling air and an outlet where the cooling unit draws out the cooling air are each provided at different faces of the housing member.

21. The projection display apparatus according to claim 20, further comprising at least one another cooling unit different from the cooling unit,
one of the cooling unit and the another cooling unit cools a high temperature heat source, and the other of the cooling unit and the another cooling unit cools a low temperature heat source having a temperature lower than that of the high temperature heat source.
